(19) United States
(12) Patent Application Publication
(10) Pub. No.: US 2010/0013764 A1
(43) Pub. Date: Jan. 21, 2010

(54) Devices for Controlling Computers and Devices

(76) Inventors: Wei Gu, Stanford, CA (US); Daniel Zhiling Shen, Stanford, CA (US)

Correspondence Address: SHAY GLENN LLP, 2755 CAMPUS DRIVE, SUITE 210, SAN MATEO, CA, 94403, US

(21) Appl. No.: 12/505,315

(22) Filed: Jul. 17, 2009

Related U.S. Application Data
(60) Provisional application No. 61/135,176, filed on Jul. 18, 2008.
(60) Provisional application No. 61/158,421, filed on Mar. 9, 2009.

(51) Int. Cl. G06F 3/033

(52) U.S. Cl. 345/158

(57) ABSTRACT

One aspect of the invention provides a device for providing input to a computer. In some embodiments, the device includes a body, first and second reflective elements that have at least a first configuration and a second configuration, and a movable member coupled to the body. The movable member may be configured to move from a first position to a second position under an applied load, such that the reflective elements change from the first configuration to the second configuration, and then return to the first position.

### CROSS-REFERENCE TO RELATED APPLICATIONS

This application claims priority to U.S. Provisional Patent Application No. 61/135,176, titled “TRACKING MODALITIES FOR USE IN TOUCHLESS CONTROL OF COMPUTERS AND DEVICES FOR MEDICAL OPERATIONS AND PROCEDURES”, filed on Jul. 18, 2008, which is herein incorporated by reference in its entirety. This application also claims priority to U.S. Provisional Patent Application No. 61/158,421, titled “REFLECTOR BASED CONTROL OF COMPUTERS AND DEVICES FOR MEDICAL OPERATIONS AND PROCEDURES”, filed on Mar. 9, 2009, which is herein incorporated by reference in its entirety.

### BACKGROUND OF THE INVENTION

Conventional intra-procedural image processing, viewing, and manipulation may involve interfacing methods using a bagged or covered mouse, touch screen, or joystick. These methods suffer from diminished control and speed and can clutter the operating environment. This may lead many physicians to leave the sterile field to use a standard, non-sterile mouse. Leaving the sterile filed and/or “unscrubbing” lengthens the time of the procedure and potentially puts the patient at a greater risk. This may also cost the medical practitioner and hospital/clinic added time and increases the use of materials. Furthermore, it may compromise the overall sterility of the procedure.

There are many instances where a physician who has scrubbed-in for a sterile environment will want to have control over computers and instruments without breaking sterility. Such situations may include viewing and panning through data-rich radiographic scans (e.g., Computed tomography (CT) images via picture archiving and communication systems (PACS)), looking up lab values and case details, controlling devices in real-time (e.g., rotating a C-arm or Fluoroscope), reviewing references, pointing out details on images, and drawing schematics and game plans. Thus, it may be desirable to provide new devices, systems and methods for providing input to a computer.

Alternative computer input devices have been described in the prior art. Some prior art devices track movement of a single retroreflector to provide the computer input. Other prior art devices use multiple retroreflectors, but do so in a way that is prone to misuse by the user or misinterpretation by the computer. Some prior art systems are unnecessarily complex, requiring, e.g., use of a focusing lens with the photodetector. Examples of such prior art devices may be found in U.S. Pat. No. 6,791,531, which describes multiple embodiments of an optical cursor control system that can be mounted to a user's hand, head, etc.

### SUMMARY OF THE INVENTION

Optical computer input devices should provide robust, reliable computer input signals. It is important to minimize input errors due to light from other reflectors or light sources as well as from misinterpretation of the desired input from the actual optical computer input device. It is also desirable to be able use the computer input device with more than one computer or computer-based device and for the device to be able to perform multiple different kinds of computer input operations.

In addition, optical computer input devices used in a medical environment, such as an in an operating room, should be sterile and disposable. The devices should therefore be made from materials that can tolerate common sterilization techniques, such as autoclaving, and inexpensive enough to be disposed of after a single use. The devices also should be able to communicate from within a sterile field to a computer or computer-based device outside the sterile field.

Described herein are devices, systems and methods for providing input to a computer. In general, the devices may include a body, first and second reflective elements that have at least a first configuration and a second configuration, and a movable member coupled to the body. The movable member may be configured to move from a first position to a second position under an applied load and then return to the first position. In general, the movable member moves such that the reflective elements change from the first configuration to the second configuration. In general, the methods may include the steps of emitting light from a registered light source, reflecting a first pattern of reflected light emitted by the registered light source from at least first and second reflective elements, moving a movable member, coupled to a body, with respect to the body to create a second pattern of reflected light from the at least two reflective elements, and detecting a change from the first pattern to the second pattern to perform at least one of a computer mouse click, a computer mouse scroll, a keyboard input, and a combination thereof.

One aspect of the invention provides computer input system including a registered light source that emits light and an interface including first and second reflective elements configured to reflect light emitted by the registered light source, a body, and a movable member coupled to the body. A portion of the movable member is movable with respect to the body to change the light reflected from the first and second reflective elements from at least a first pattern to a second pattern. In some embodiments, the system also includes a detector configured to detect light reflected by the first and second reflective elements and to generate a signal corresponding to the detected light and a processor configured to receive the signal generated by the detector and to identify a change from the first pattern to the second pattern to perform a computer input operation. The computer input operation may be a computer mouse click, a computer mouse scroll, a keyboard input, and/or a combination thereof.

In some embodiments, the registered light source is positioned to emit light into the sterile field and the interface is disposed inside the sterile field. In some embodiments, the first and second reflective elements are sterilizable.

In some embodiments, the second reflective element is coupled to the movable member and is movable with respect to the first reflective element and in some embodiments, the first reflective element is coupled to a second movable member coupled to the body, and a portion of the second movable member is movable with respect to the body. In some embodiments, the interface further includes a third reflective element that is configured to reflect light emitted by the registered light source, and the first and second reflective elements are movable with respect to the third reflective element. In some embodiments, a change in position of the second reflective element with respect to the first or third reflective element performs a different computer input operation than the change from the first pattern to the second pattern.

In some embodiments, the second reflective element moves with respect to the first reflective element such that the detector ceases to detect reflected light from at least one of the reflective elements, and the obstruction of at least one of the reflective elements changes the reflected pattern of light from the first pattern to the second pattern.

In some embodiments, the second reflective element moves with respect to the first reflective element such that a portion of the body obstructs the second reflective element and the detector ceases to detect light from the second reflective element.

In some embodiments, the first reflective element is coupled to the body of the interface, and in some embodiments, the interface further includes a second movable member coupled to the body, a portion of the second movable member is movable with respect to the body, and a third reflective element that reflects light emitted by the registered light source and is coupled to the second movable member. The second and third reflective elements may be movable with respect to the first reflective element and the detector is further configured to detect light from the third reflective element. In some embodiments, the processor is further configured to identify a change in position of the third reflective element with respect to at least the first or second reflective element to perform a computer input operation different than the computer input operation performed in response to the change from the first pattern to the second pattern.

In some embodiments, the movable member is configured to permit the second reflective element to move with respect to the first reflective element from a position which prevents light from being reflected from the second reflective element to the detector to a position which permits- light to be reflected from the second reflective element to the detector to change the reflected pattern of light from the first pattern to the second pattern.

In some embodiments, the movable member is configured to move with respect to the body to prevent light from being reflected from at least one of the reflective elements, and preventing reflected light from at least one of the reflective elements changes the reflected pattern of light from the first pattern to the second pattern. In some embodiments, the movable member is configured to move with respect to the body such that a portion of the movable member obstructs light reflected from the second reflective element to the detector. In some embodiments, the movable member is configured to move with respect to the body to expose at least one of the reflective elements to permit the detector to detect light from at least one of the reflective elements to change the reflected pattern of light from the first pattern to the second pattern.

In some embodiments, the system further includes a second interface that includes a third reflective element and a fourth reflective element, and the third and fourth reflective elements are configured to reflect a third pattern of reflected light emitted by the registered light source that is distinct from the first and second patterns and a fourth pattern of reflected light emitted by the registered light source that is distinct from the first, second and third patterns, the detector being further configured to detect light reflected by the third and fourth reflective elements and to generate a signal corresponding to the detected light, the processor being further configured to receive the signal generated by the detector and to identify a change from the third pattern to the fourth pattern to perform a computer input operation. In some embodiments, the first and second reflective elements have a first spectral response and the third and fourth reflective elements have a second spectral response, and the first spectral response is different from the second spectral response. In some embodiments, the first and second reflective elements are each configured to reflect a first shape of light and the third and fourth reflective elements each configured to reflect a second shape of light, and the first shape is different from the second shape. In some embodiments, the processor is further configured to identify the first and second patterns as being from the first interface and to identify the third and fourth patterns as being from the second interface. In some embodiments, the processor is further configured to identify the first interface as being dominant over the second interface. In some embodiments, the processor is further configured to use a first calibration setting with the first interface and a second calibration setting with the second interface. In some embodiments, the processor is further configured to detect movement of at least one of the first and second reflective elements and to translate the movement to movement of a first cursor on a screen and to detect movement of at least one of the third and fourth reflective elements and to translate the movement to movement of a second cursor on a screen.

In some embodiments, the first and second reflective elements have a first orientation with respect to the body, the interface further includes a third reflective element and a fourth reflective element having a second orientation with respect to the body, and the third reflective element is configured to move with respect to the fourth reflective element such that they reflect a third pattern of reflected light emitted by the registered light source that is distinct from the first pattern and a fourth pattern of reflected light emitted by the registered light source that is distinct from the second pattern. The detector may be further configured to detect light reflected by the third and fourth reflective elements and to generate a signal corresponding to the detected light. The processor may be further configured to receive the signal generated by the detector and to identify a change from the third pattern to the fourth pattern to perform a computer input operation. In some embodiments, the third reflective element and the fourth reflective element are positioned substantially opposite form the first and second reflective elements with respect to the body. In some embodiments, the change identified by the processor from the third pattern to the fourth pattern performs a different computer input operation than the change identified by the processor from the first pattern to the second pattern. In some embodiments, the change identified by the processor from the third pattern to the fourth pattern switches the system from providing the computer input operation to a first computer to providing the computer input operation to a second computer.

In some embodiments, the first and second reflective elements have a first orientation with respect to the body, the interface further includes a third reflective element having a second orientation with respect to the body, and the third reflective element reflects a third pattern of reflected light emitted by the registered light source that is distinct from the first pattern and the second pattern, The detector may be further configured to detect light reflected by the third reflective element and to generate a signal corresponding to the detected light. The processor may be further configured to receive the signal generated by the detector and to identify the third pattern to perform a computer input operation. In some embodiments, the third reflective element is positioned substantially opposite form the first and second reflective elements with respect to the body. In some embodiments, the third pattern identified by the processor performs a different computer input operation than the change identified by the processor from the first pattern to the second pattern. In some embodiments, the third pattern identified by the processor switches the system from providing a computer input operation to a first computer to providing a computer input operation to a second computer.

In some embodiments, the interface further includes a third reflective element adapted to be coupled to a head of a user to reflect a third pattern of reflected light emitted by the registered light source that is distinct from the first pattern and the second pattern.

In some embodiments, the registered light source is an infrared light source and the first reflective element and the second reflective element comprise infrared reflective material. In some embodiments, the detector includes an infrared camera system.

In some embodiments, the first reflective element has a first spectral response and the second reflective element has a second spectral response, and the first spectral response is different from the second spectral response. In some embodiments, the first reflective element reflects a first shape of light and the second reflective element reflects a second shape of light, and the first shape is different from the second shape.

In some embodiments, the body is a glove and the movable member is a digit of the glove. In some embodiments, the body is a device sized and configured to be worn by a user. In some embodiments, the first reflective element is adapted to be coupled to a head of a user and the processor is further configured to detect movement of at least one reflective element and to translate the movement of the at least one reflective element to movement of a cursor on a screen.

In some embodiments, the body is a handheld device and the movable member includes a cantilever beam coupled to the handheld device. In some embodiments, the cantilever beam is resilient, and the cantilever beam is configured to bend under an applied force and return to an equilibrium position upon release of the force. In some embodiments, the body is a surgical instrument and the movable member is a movable portion of the surgical instrument. In some embodiments, the surgical instrument is a forceps having a first movable member and a second movable member, and each of the first and second reflective elements are coupled to a moveable member and the change in position of the first reflective element with respect to the second reflective element occurs by changing the distance between the reflective elements. In some embodiments, at least one of the body and the movable member is sized and configured to be coupled to a surgical instrument. In some embodiments, the interface further includes a cage coupled to the movable member, sized and configured to receive a digit of a user.

In some embodiments, the interface further includes a spring, coupled to the movable member that is sized and configured to allow the movable member to move with respect to the body under an applied force and return to an equilibrium position upon release of the force.

In some embodiments, the movable member slides with respect to the body. In some embodiments, the system further includes a pivot, and the movable member rotates about the pivot with respect to the body. In some embodiments, the movable member is coupled to the body so as to be movable in one direction against gravity and movable in an opposite direction with gravity.

In some embodiments, the system further includes a foot pedal, and activating the foot pedal performs at least one of a computer mouse click, a computer mouse scroll, a keyboard input, and a combination thereof.

In some embodiments, the detector is further configured to detect a voice command and to generate a signal corresponding to a detected voice command, and the processor is further configured to receive a voice command signal from the detector to perform at least one of a computer mouse click, a computer mouse scroll, a keyboard input, and a combination thereof.

In some embodiments, the system further includes a second detector configured to detect light reflected by the first and second reflective elements and to generate a signal corresponding to the detected light, and the processor is further configured to receive the signal from the second detector and to identify a change in position of the reflective elements to perform a different computer input operation than the computer input operation performed in response to a signal generated by the first detector. In some embodiments, the change in position of the reflective elements detected by the second detector switches the system from providing input to a first computer to providing input to a second computer.

In some embodiments, the system further includes a viewing system having a screen. In some embodiments, the viewing system is positioned adjacent to the detector, and the viewing system and the detector are pointing in substantially the same direction. In some embodiments, identification of the change from the first pattern to the second pattern further performs at least one of changing an image on the viewing screen, selecting an item on the viewing screen, selecting and dragging an item across the viewing screen, changing function of a cursor, initiating drawing on the viewing screen, stopping drawing on the viewing screen, and measuring a distance on the screen. In some embodiments, the detector is further adapted to detect movement of the body by detecting movement of at least one of the reflective elements on the body, the processor being further adapted to translate the movement of the body to movement of a cursor on the screen. In some embodiments, the screen includes an image of a button and the change from the first pattern to the second pattern activates the button. In some embodiments, the button is a digital representation of a control mechanism of a physical user interface. In some embodiments, the viewing system includes a first image and second image, and identification of the change from the first pattern to the second pattern by the processor initiates a change from the first image to the second image.

In some embodiments, the system further includes a shield that prevents obstruction of the light reflected from the reflective elements to the detector. In some embodiments, the detector is further adapted to initiate an indication upon detection of the change from the first pattern to the second pattern. In some embodiments, the indication is a visible indication. In some embodiments, the indication is an audible indication.

In some embodiments, the system further includes a laser pointer, and the processor is further configured to detect the movement of at least one of the reflective elements and translate the movement of the reflective element to movement of the laser pointer.

Another aspect of the invention provides a device for providing input to a computer. In some embodiments, the device includes a body, first and second reflective elements that have at least a first configuration and a second configuration, and a movable member coupled to the body. The movable member may be configured to move from a first position to a second position under an applied load, such that the reflective elements change from the first configuration to the second configuration, and then return to the first position. In some embodiments, the movable member is configured to return to the first position upon release of the applied load. In some embodiments, the first and second reflective elements are sterilizable and/or the body is sterilizable. In some embodiments, the first reflective element includes a material that has a first spectral response and the second reflective element includes a material has a second spectral response that is different from the first spectral response. In some embodiments, the first reflective element and the second reflective element include infrared reflective material. In some embodiments, the first reflective element has a first shape and the second reflective element has a second shape that is different from the first shape.

In some embodiments, the second reflective element is coupled to the movable member and is movable with respect to the first reflective element. The first reflective element may be sized and configured to be coupled to the body. The interface may include a second movable member sized and configured to be coupled to the body and a third reflective element coupled to the second movable member. The second and third reflective elements may be movable with respect to the first reflective element.

In some embodiments, the first reflective element is coupled to a second movable member and the interface may further include a third reflective element and the first and second reflective elements maybe movable with respect to the third reflective element.

In some embodiments, the second reflective element moves with respect to the first reflective element such that at least one of the reflective elements is obstructed by a portion of the device. While in some embodiments, the movable member moves with respect to the body such that at least one of the reflective elements is obstructed by a portion of the movable member. Alternatively, in some embodiments, the second reflective element moves with respect to the first reflective element such that at least one of the reflective elements is exposed by a portion of the device. While in some embodiments, the movable member moves with respect to the body such that at least one of the reflective elements is exposed by a portion of the movable member.

In some embodiments, the first and second reflective elements have a first orientation with respect to the body, and the device further includes a third reflective element having a second orientation with respect to the body. In some embodiments, the third reflective element is positioned substantially opposite from the first and second reflective elements with respect to the body. In some embodiments, the third reflective element is distinct from at least one of the first reflective element, the second reflective element, and the combination thereof. In some embodiments, the device further includes a fourth reflective element having a second orientation with respect to the body and the third and fourth reflective elements have at least a third configuration and a fourth configuration. In some embodiments, the third and fourth reflective elements are distinct from the first and second reflective elements, while in some embodiments, the third and fourth configurations are distinct from the first and second configurations, respectively.

In some embodiments, the body is a device sized and configured to be worn by a user.

In some embodiments, the body is a handheld device and the movable member is a cantilever beam coupled to the handheld device. In some embodiments, the cantilever beam is resilient and is configured to bend from a first position to a second position under an applied load and return to the first position upon release of the applied load. In some embodiments, the device further includes a cage coupled to the movable member and sized and configured to receive a digit of a user. In some embodiments, the device further includes a spring, coupled to the movable member that is sized and configured to allow the movable member to move from a first position to a second position under an applied load and to return the movable member to the first position upon release of the applied load.

In some embodiments, the movable member is coupled to the body so as to be movable in one direction against gravity and movable in an opposite direction with gravity. In some embodiments, the movable member slides with respect to the body. In some embodiments, the device further includes a pivot and the movable member rotates about the pivot with respect to the body.

In some embodiments, the body is a surgical instrument and the movable member is a movable portion of the surgical instrument. In some embodiments, the surgical instrument is a forceps having a first movable member and a second movable member and the movable member moves from the first position to the second position by approximating the movable members.

Another aspect of the invention provides a method for providing input to a computer. In some embodiments, the method includes the steps of emitting light from a registered light source, reflecting a first pattern of reflected light emitted by the registered light source from at least first and second reflective elements, moving a movable member, coupled to a body, with respect to the body to create a second pattern of reflected light from the at least two reflective elements, and detecting a change from the first pattern to the second pattern to perform at least one of a computer mouse click, a computer mouse scroll, a keyboard input, and a combination thereof.

In some embodiments, the emitting step includes emitting light into a sterile field and the reflecting step includes reflecting a first pattern of light from at least first and second reflective elements in the sterile field.

In some embodiments, the moving step includes applying a force to the movable member to move the movable member from a first position to a second position. In some embodiments, the method further includes the step of releasing the force from the movable member to permit the movable member to move from the second position to the first position. In some embodiments, the applying step includes applying the force against a spring force, and in some embodiments, the applying step includes applying the force against gravity.

In some embodiments, the emitting step includes emitting infrared light and in some embodiments, the detecting step includes detecting a change from a first pattern of reflected infrared light to the second pattern of reflected infrared light.

In some embodiments, the method further includes the step of translating the movement of at least one of the reflective elements to movement of a cursor on a viewing screen. In some embodiments, the detecting step further includes the step of detecting a change from the first pattern to the second pattern to activate a button on a viewing screen. In some embodiments, the detecting step further includes the step of detecting a change from the first pattern to the second pattern to activate a digital representation of a control mechanism of a physical user interface.

In some embodiments, the moving step includes moving the first reflective element coupled to the movable member with respect to a second reflective element coupled to a body.

In some embodiments, the moving step includes moving the first reflective element coupled to the movable member with respect to a second reflective element coupled to a second movable member.

In some embodiments, the method further includes the steps of moving a third reflective element with respect to the first or second reflective element to create a third pattern of reflected light and detecting a change from the first or second pattern to the third pattern to perform a different function than detecting a change from the first pattern to the second pattern.

In some embodiments, the moving step includes moving the first reflective element coupled to the movable member with respect to the second reflective element to obstruct at least one of the reflective elements to create the second pattern of reflected light. In some embodiments, the moving step includes moving the first reflective element coupled to the movable member with respect to a second reflective element such that a portion of the body obstructs the second reflective element to create the second pattern of reflected light.

In some embodiments, the moving step includes moving the movable member with respect to the body to obstruct at least one of the reflective elements to create the second pattern of reflected light. In some embodiments, the moving step includes moving the movable member with respect to the body such that a portion of the movable member obstructs the second reflective element to create the second pattern of reflected light.

In some embodiments, the moving step includes moving the first reflective element coupled to the movable member from an obstructed position to an unobstructed position where the detector detects light from the second reflective element.

In some embodiments, the moving step includes moving the movable member to expose at least one of the reflective elements such that the detector detects light from at least one of the reflective elements.

In some embodiments, the method further includes the step of rotating the body about an axis of the body.

In some embodiments, the method further includes the step of activating a foot pedal to perform at least one of a computer mouse click, a computer mouse scroll, a keyboard input, and a combination thereof.

In some embodiments, the method further includes the step of detecting an audible command, and the audible command performs at least one of a computer mouse click, a computer mouse scroll, a keyboard input, and a combination thereof.

In some embodiments, the method further includes the step of initiating a change from a first visible screen of a viewing system to a second visible screen of a viewing system.

In some embodiments, the method further includes the step of moving a third reflective element coupled to a head of a user with respect to the first or second reflective element.

In some embodiments, the method further includes the step of translating the movement of the third reflective element to movement of a cursor on a viewing screen.

In some embodiments, the method further includes the step of activating a foot pedal to perform at least one of a computer mouse click, a computer mouse scroll, a keyboard input, and a combination thereof.

In some embodiments, the moving step includes moving the movable member by bending the movable member.

In some embodiments, the method further includes the step of initiating a signal upon detection of the change in pattern. In some embodiments, the method further includes the step of initiating visible signal. In some embodiments, the method further includes the step of initiating an audible signal.

Another aspect of the invention provides a method for providing input to a computer. In some embodiments, the method includes the steps of emitting light from a registered light source, reflecting a first pattern of light emitted by the registered light source with at least two reflective elements, detecting the movement of at least one of the reflective elements, and translating the movement of the at least one reflective element to movement of a cursor on a viewing system such that there is a first relationship between the movement of the at least one reflective element and the movement of the cursor, detecting a change from the first pattern to a second pattern of light with the at least two reflective elements, and changing the relationship between the movement of the reflective element and the movement of the cursor from the first relationship to a second relationship.

In some embodiments, the emitting step includes emitting light into a sterile field and the reflecting step includes reflecting a first pattern of light from at least first and second reflective elements in the sterile field.

In some embodiments, the translating step further includes translating the movement of the reflective element to movement of a cursor on a viewing system, such that there is a first relationship between the distance the reflective element travels and the distance of the cursor travels across the viewing system. In some embodiments, the translating step further includes translating the movement of the reflective element to movement of a cursor on a viewing system and the first relationship is a direct relationship between the distance the reflective element travels and the distance of the cursor travels across the viewing system. In some embodiments, the translating step further includes translating the movement of the reflective element to movement of a cursor on a viewing system such that a function of the distance the reflective element travels is equal to the distance of the cursor travels across the viewing system. In some embodiments, the function is a linear function and the distance the reflective element travels, multiplied by a constant, is equal to the distance of the cursor travels across the viewing system. In some embodiments, the function of the distance the reflective element travels is such that the distance of the cursor travels across the viewing system is less than the distance the reflective element travels. In some embodiments, the function of the distance the reflective element travels is such that the distance of the cursor travels across the viewing system is greater than the distance the reflective element travels. In some embodiments, the changing step further includes changing the function of the distance the reflective element travels from a first preset function to a second preset function. In some embodiments, the detecting the movement step further includes detecting the distance of at least two reflective elements from a detector. In some embodiments, the function is dependent on the distance of at least one reflective element from the detector.

In some embodiments, the changing step further includes changing the relationship between the movement of the reflective element and the movement of the cursor from the first relationship to a second relationship such that the position of the cursor is centered on the viewing system. In some embodiments, the detecting a change in position step further includes detecting a rotation of the first reflective element about the second reflective element. In some embodiments, the detecting a change in position step further includes detecting a rotation of the first reflective element and the second reflective element.

In some embodiments, the detecting a change in position step is performed continuously and in some embodiments, the detecting a change in position step is repeated at a rate of at least 0. I Hz.

In some embodiments, the method further includes the step of moving a movable member, coupled to a body, with respect to the body to reflect a second pattern of light with the at least two reflective elements. In some embodiments, the moving step includes moving the movable member with respect to the body to obstruct at least one of the reflective elements such that a detector ceases to detect reflected light from at least one of the reflective elements. In some embodiments, the moving step includes moving the movable member with respect to the body to expose at least one of the reflective elements such that a detector detects light from at least one of the reflective elements.

Another aspect of the invention provides a method for providing input to a first computer and a second computer. In some embodiments, the method includes the steps of emitting light from a registered light source, reflecting light emitted by the registered light source with a reflective element, detecting the movement of the reflective element, translating the movement of the reflective element to movement of a cursor on a viewing system coupled to the first computer, detecting a computer switching input from a reflective element, and translating the movement of the reflective element to movement of a cursor on a viewing system coupled to the second computer.

In some embodiments, the emitting step includes emitting light into a sterile field and the reflecting step includes reflecting with a reflective element in the sterile field.

In some embodiments, the viewing system coupled to the second computer is the viewing system connected to the first computer.

In some embodiments, the translating step further includes translating the movement of the reflective element to movement of a cursor on a viewing system, and the viewing system includes a plurality of screens.

In some embodiments, the viewing system includes a first screen coupled to the first computer and a second screen coupled to the second computer. In some embodiments, the viewing system includes a screen that displays a first image coupled to the first computer and a second image coupled to the second computer. In some embodiments, the first computer is coupled to a first viewing system and the second computer is coupled to a second viewing system.

In some embodiments, the reflecting step includes reflecting a first pattern of reflected light emitted by the registered light source from at least first and second reflective elements, at least one reflective element being coupled to a movable member of a body, and moving the first reflective element with respect to the body to create a second pattern of reflected light from the at least two reflective elements in the sterile field. In some embodiments, the method further includes the step of detecting a change from the first pattern to the second pattern to perform at least one of a computer mouse click, a computer mouse scroll, a keyboard input, and a combination thereof with the first computer.

In some embodiments, the detecting a computer switching input step includes reflecting a third pattern of reflected light emitted by the registered light source from at least third and fourth reflective elements in the sterile field positioned substantially opposite from the first and second reflective elements with respect to the body, moving the third reflective element with respect to the body to create a fourth pattern of reflected light from the at least two reflective elements in the sterile field, and detecting a change from the third pattern to the fourth pattern. In some embodiments, after the detecting a computer switching input step, the method further includes the step of detecting a change from the first pattern to the second pattern to perform at least one of a computer mouse click, a computer mouse scroll, a keyboard input, and a combination thereof with the second computer.

In some embodiments, the detecting a computer switching input step includes reflecting a third pattern of reflected light emitted by the registered light source from a third reflective element positioned substantially opposite from the first and second reflective elements with respect to the body, and detecting the third pattern of reflected light. In some embodiments, after the detecting a computer switching input step, the method further includes the step of detecting a change from the first pattern to the second pattern to perform at least one of a computer mouse click, a computer mouse scroll, a keyboard input, and a combination thereof with the second computer.

In some embodiments, the detecting a computer switching input step includes reflecting a first pattern of reflected light emitted by the registered light source from at least first and second reflective elements in the sterile field, at least one reflective element being coupled to a movable member of a body, moving the first reflective element with respect to the body to create a second pattern of reflected light from the at least two reflective elements in the sterile field, and detecting a change from the first pattern to the second pattern.

In some embodiments, the detecting the movement of the reflective element step is performed by a first detector and the detecting a computer switching input from a reflective element step is performed by a second detector. In some embodiments, the second detector is positioned at an angle about 90 degrees from the first detector. In some embodiments, the reflecting step includes reflecting a first pattern of reflected light emitted by the registered light source from at least first and second reflective elements in the sterile field, at least one reflective element being coupled to a movable member of a body, and moving the first reflective element with respect to the body to create a second pattern of reflected light from the at least two reflective elements in the sterile field. In some embodiments, the method further includes the step of detecting with the first detector a change from the first pattern to the second pattern to perform at least one of a computer mouse click, a computer mouse scroll, a keyboard input, and a combination thereof with the first computer. In some embodiments, the detecting a computer switching input step further includes detecting with the second detector a change from the first pattern to the second pattern. In some embodiments, after the detecting a computer switching input step, the method further includes the step of detecting with the first detector a change from the first pattern to the second pattern to perform at least one of a computer mouse click, a computer mouse scroll, a keyboard input, and a combination thereof with the second computer.

Another aspect of the invention provides a method for providing input to a computer. In some embodiments, the method includes the steps of emitting light from a registered light source, reflecting light emitted by the registered light source with a reflective element, defining a range of motion of the reflective element, detecting movement of the reflective element, and translating the movement of the reflective element to a movement of a cursor on a viewing system. The viewing system defines a viewing area and there is a relationship between the range of motion of the reflective element and the viewing area.

In some embodiments, the defining step further includes defining the center of the range of motion and the translating step further includes translating the movement of the reflective element to a centered position of the cursor on the viewing area when the reflective element is positioned substantially at the center of the range of motion.

In some embodiments, the defining step further includes moving the reflective element around the periphery of the range of motion and detecting the movement of the reflective element.

In some embodiments, the reflecting step further includes reflecting a first pattern of reflected light emitted by the registered light source from at least first and second reflective element, each reflective element being coupled to a body. In some embodiments, the defining step further includes positioning the body at a first location substantially along the periphery of the range of motion, moving the first reflective element with respect to the body to create a second pattern of reflected light from the at least two reflective elements, and detecting a change from the first pattern to the second pattern to perform a computer mouse click. In some embodiments, the defining step further includes positioning the body at a second location substantially along the periphery of the range of motion and detecting a change from the first pattern to the second pattern to perform a computer mouse click.

In some embodiments, the method further includes the step of reflecting light emitted by the registered light source with a second reflective element that is in a substantially fixed position with respect to the range of motion of the first reflective element. In some embodiments, the defining step further includes detecting the position of the first reflective element with respect to the second, fixed reflective element. In some embodiments, the method further includes the step of reflecting light emitted by the registered light source with a third reflective element that is in a substantially fixed position with respect to the range of motion of the first reflective element.

In some embodiments, the translating step further includes translating the movement of the reflective element to a movement of a cursor on a viewing system and the viewing system defines a viewing area that includes a screen.

In some embodiments, the translating step further includes translating the movement of the reflective element to a movement of a cursor on a viewing system and the viewing system defines a viewing area that includes a plurality of screens.

In some embodiments, the method further includes the step of activating a foot pedal to perform a computer mouse click.

In some embodiments, the method further includes the step of receiving a voice command to perform a computer mouse click.

In some embodiments, the detecting step further includes detecting the movement of the reflective element outside of the defined range of motion and the translating step further includes translating the movement of the reflective element to a movement of a cursor on the viewing area and the position of the cursor on the viewing area is at an edge of the viewing area.

### INCORPORATION BY REFERENCE

All publications and patent applications mentioned in this specification are herein incorporated by reference in their entirety, as if each individual publication or patent application was specifically and individually indicated to be incorporated by reference in its entirety.

### BRIEF DESCRIPTION OF THE DRAWINGS

FIG. 1 is a schematic block diagram illustrating the main components of a system for providing input to a computer according to one aspect of the invention.

FIG. 2 shows a system and method of use for providing input to a computer according to one aspect of the invention.

FIG. 3 shows a system including multiple interfaces and method of use for providing input to a computer according to one aspect of the invention.

FIGS. 4A and 4B show various reflective elements according to one aspect of the invention.

FIG. 5 shows a system and method of use for providing input to a computer according to one aspect of the invention.

FIG. 6 shows a reflective element according to one aspect of the invention.

FIG. 7 shows a system and method of use for providing input to a computer, specifically for training, according to one aspect of the invention.

FIG. 8 shows a system including multiple detectors and method of use for providing input to a computer according to one aspect of the invention.

FIGS. 9A-9C show a viewing system according to one aspect of the invention.

FIG. 10 shows a system including a laser pointer and method of use for providing input to a computer according to one aspect of the invention.

FIGS. 11A-11C show a device and method of use for providing input to a computer according to one aspect of the invention.

FIGS. 12A-13B show multiple patterns of reflected light according to one aspect of the invention.

FIGS. 14A and 14B show a device and method of use for providing input to a computer according to one aspect of the invention.

FIGS. 15A and 15B show a device and method of use for providing input to a computer according to one aspect of the invention.

FIGS. 16A-16C show a device and method of use for providing input to a computer according to one aspect of the invention.

FIGS. 17A-17D show a device and method of use for providing input to a computer according to one aspect of the invention.

FIGS. 18A-18C show a device having a cage and method of use for providing input to a computer according to one aspect of the invention.

FIG. 19 shows a cage according to one aspect of the invention.

FIGS. 20A and 20B show a device having a sliding movable member and method of use for providing input to a computer according to one aspect of the invention.

FIGS. 21A-21C show a device having a pivot and method of use for providing input to a computer according to one aspect of the invention.

FIGS. 22A and 22B show a device having a screen and method of use for providing input to a computer according to one aspect of the invention.

FIGS. 23A and 23B show a device having a pivot and method of use for providing input to a computer according to one aspect of the invention.

FIGS. 24A and 24B show a device having a cage and method of use for providing input to a computer according to one aspect of the invention.

FIG. 25 shows a device having a third reflective element in a different orientation and method of use for providing input to a computer according to one aspect of the invention.

FIG. 26 shows a device having a third and fourth reflective element in a different orientation and method of use for providing input to a computer according to one aspect of the invention.

FIGS. 27A-29 show various devices and methods of use for providing input to a computer according to one aspect of the invention.

FIG. 30 shows a device having a shield and method of use for providing input to a computer according to one aspect of the invention.

FIG. 31 shows schematically a distance of a reflective element from a detector.

FIG. 32 shows a system and method of use for providing input to a computer according to one aspect of the invention.

FIGS. 33A-35 show devices and methods of defining a range of motion according to one aspect of the invention.

### DETAILED DESCRIPTION OF THE INVENTION

Described herein are devices, systems and methods for providing input to a computer. In general, the devices may include a body, first and second reflective elements that have at least a first configuration and a second configuration, and a movable member coupled to the body. The movable member may be configured to move from a first position to a second position under an applied load and then return to the first position. In general, the movable member moves such that the configuration of the reflective elements changes from the first configuration to the second configuration. In general, the methods may include the steps of emitting light from a registered light source, reflecting a first pattern of reflected light emitted by the registered light source from at least first and second reflective elements, moving a movable member, coupled to a body, with respect to the body to create a second pattern of reflected light from the at least two reflective elements, and detecting a change from the first pattern to the second pattern to perform at least one of a computer mouse click, a computer mouse scroll, a keyboard input, and a combination thereof.

The devices, systems, methods, and any combination thereof for providing input to a computer described herein provide at least the following advantages. First, users (such as surgeons or other medical service providers) will not need to break sterility in order to use a computer by themselves, nor will they need to introduce another piece of sterile input interface close to them in an already cluttered sterile field. There will be no added cost to a procedure, as the system will replace conventional sterile covers for the input devices that currently need to be replaced for each operation. Furthermore, other computerized equipment can be integrated into these systems and methods in ways that are flexible for different users and types of procedures. A user may also control computers and instrumentation from a distance using the disclosed devices, systems and method. It may be advantageous for the user to maintain one position without the need for superfluous control mechanisms. A user also avoids touching objects in general, and more specifically avoids touching objects such as keyboards and mice that may be pathogen reservoirs and avoids contaminating the touched controls with a dirty (gloved) hand. The system also allows an individual to operate technology by movement of their appendages (fingers, arms, head) when other appendages are occupied with other tasks.

Further advantages of the devices for providing input to a computer described herein include that the device may be sterilizable and disposable. This may prevent the need for sterile bagging of input devices and/or the development and use of re-sterilization procedures. Disposability of the device also reduces the consequences of throwing away, tampering, or destroying the handheld device. The device may not include electronic components or a battery, which prevents the cost and/or the difficulty of sterilizing electronic or battery components. The device can be operated with one hand such that the other hand of the user may be preoccupied with instruments and other surgical equipment or devices. The operation of the device is intuitive, fast to engage, and easy to use without a steep learning curve. Furthermore, the disposable device is not physically tethered to large capital equipment or furniture, the device is mobile, portable, and has small footprint. Additionally, the device may not inhibit wireless compatible in the operating room or clinic. For example, infrared wireless does not interfere with radiofrequency wireless.

### System for Providing Input to a Computer

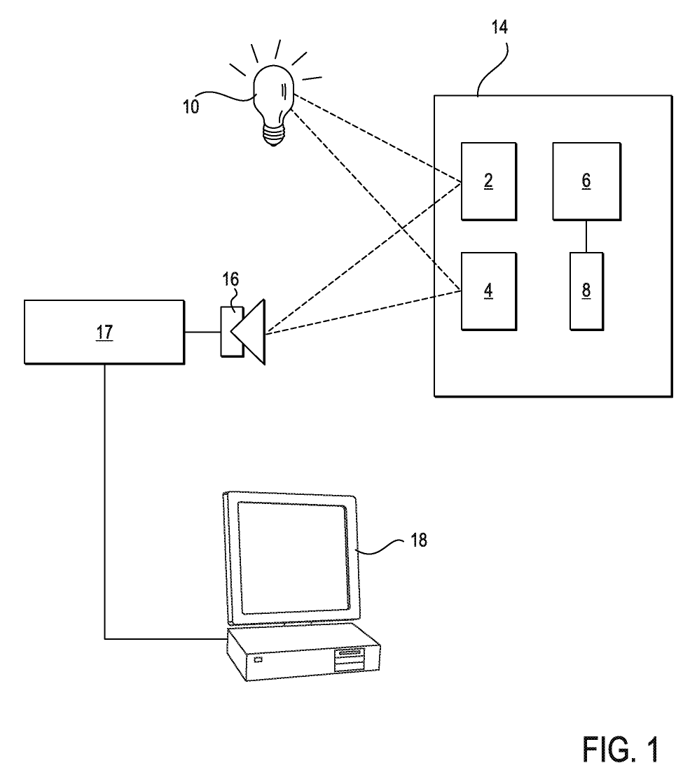

FIG. 1 is a schematic block diagram illustrating the main components of a system for providing input to a computer according to one aspect of the invention. A registered light source 10 emits light (shown by the dotted lines) toward two reflective elements 2 and 4 of an interface 14 to a detector 16. Interface 14 also has a body 6 and a movable member 8 coupled to the body. The movable member may be moved with respect to the body to change the pattern of light reflected by at least two reflective elements 2 and 4 from at least a first pattern to a second pattern to be detected by detector 16. The use of a movable member to change the patterns of light from at least two reflective elements adds control and robustness to the system. Detector 16 generates a signal corresponding to the detected reflected light and sends the signal to a processor 17, which is configured to identify a change from the first pattern to the second pattern to perform a computer input operation, such as a mouse click, a mouse scroll, a keyboard input or a combination thereof.

In various embodiments, the processor 17 can be a separate element, part of the detector 16, part of computer 18, or part of another system, such as a laparoscopic surgery camera system or a dedicated sterile computer input system. The output of processor 17 is in a form recognizable to the computer as a computer input operation. Computer 18 can be a stand-alone computer or part of a larger system. Various embodiments of interface 14 and its components are discussed in more detail below.

In some embodiments, the registered light source emits light into a sterile field such as a sterile field in an operating room. The interface may be held and/used within sterile field. In this instance, the interface (including the reflective elements) may be made with sterilizable materials.

The computer that receives the input(s) from the system may be one, or any combination, of several variations. In a first variation, the computer includes navigation software. The interface may provide inputs to control settings on the navigation software. For example, such software may coordinate radiographic data with landmarks on the patient to pinpoint the location of a pointer. A navigation system may be used in neurosurgery, ear nose and throat (ENT) surgery, orthopedic surgery, etc. In a second variation, the computer includes an internet browser that can be controlled by the system.

In a third variation, the system may provide inputs to control settings (e.g., position, activation, etc.) on medical equipment such as an angiogram injector, an X-ray machine, a picture archiving and communication system (PACS), lithotripters, and/or a ultrasound machine. The system may provide inputs to control a television or video screen. The input may perform movie playback and/or step through, manipulate, and/or save movies or still images (for example, a video replay of an angiogram). The inputs may bring up and control imaging displays including fluoroscopic images, radiographic images (CT or MRI or PET images), and 3D reconstructions of anatomy. Manipulation of the images may include rotate, pan, zoom, and scroll, match newly recorded images with previously recorded images, etc. In some instances, CT or other radiographic imaging may be projected onto a patient during or before a procedure to help with planning and visualization, and the system may be used to control the projected image. For example, an interface with a reflective element can be placed over the chest area of the patient. Moving the interface towards the head of the patient may causes the projected image to scroll to a more anterior image of the CT projection. The system may provide inputs to control settings for recordings such as those for Electrophysiology (i.e., electrocardiograms (ECGs) or intracorporeal electrocardiograms (ICEGs)). For example, the computer inputs may be used to measure cardiac cycles and/or assist in diagnosing arrhythmias.

The system may also assist in recording invasive blood pressures (e.g., pressure of left/right atrium/ventricle, aorta, pulmonary artery/vein), SpO2, respiration rate and non-invasive blood pressures. The system may control a ventilator that is assisting the breathing of a patient, for example by configuring the display or adjusting the settings of the ventilator.

In a fourth Variation, the system may provide inputs to a computer in order control documents and information stored or captured by the computer such as by retrieving and recording information such as lab values, patient history, physical information, and pharmacy information on patients in the operating room, intensive care units, or elsewhere.

In a fifth variation, the system may provide inputs to surgical instruments or devices in use throughout the procedure. For example the instruments may include electric or pneumatic instruments, Bovies or other electrosurgical instruments, suction, irrigation, laparoscopic instruments, robotic instruments, etc. The system may provide inputs to control stimulation and ablation through catheters or control electronic settings in navigating a catheter. In a sixth variation, the system may provide inputs to be used as a pointer. For example, it may be used to point at images taken by camera, X-ray, endoscope, and/or laparoscope. In a seventh variation, the system may provide inputs to control aspects of the operating room such as lighting, lighting position, patient table movements, phone, pneumatics, electronics, cameras, lasers, and/or switch the display to different computers (e.g., switch a display from the PACS computer to the anesthesiology computer).

In an eighth variation, the system may provide inputs to communicate with and direct trainee surgeons and assistants in a fast, intuitive, and sterile manner. As laparoscopy has become ubiquitous in the training of General Surgeons, the challenges of teaching this new paradigm have become apparent. Among these challenges is the ability to communicate with and direct trainee surgeons and assistants in a fast, intuitive, and sterile manner. Whereas current practice is limited to mostly verbal communication, visual direction during surgery is often desired. At times, surgeons stop mid-procedure to physically point out anatomical structures. For example, the system may provide the surgeons with control of a pointer overlaid on the laparoscopic image to facilitate communication. Alternatively or additionally, the system may provide the surgeons with the ability to draw or make diagrams on the screen. For example, if a surgeon wanted to lay out where to make an incision and/or point out structures to avoid. In a ninth variation, the system may provide inputs to a computer for use in Robotic Surgery or Telemedicine.

The input from the system that controls any of the computer or computer systems described above may be one, or any combination of, several variations. In a first variation, the input is a computer mouse click. As described herein, the computer mouse click may function to select, select and drag, change screen, change image, activate a button, initiate drawing, stop drawing, computer mouse right click (i.e., access a menu of properties and context-sensitive commands), and/or any other suitable function. In a second variation, the input is a computer mouse scroll. As described herein, the computer mouse scroll may function to pan, zoom, select, and/or any other suitable function. In a third variation, the input is a keyboard input. As described herein, the keyboard input may function to select alphanumeric buttons, produce actions, provide alternative computer inputs, and/or any other suitable function.

In a fourth variation, a single input may be mapped to a sequence of mouse and or keyboard inputs (or any other suitable inputs). This set of instructions or inputs that is represented in an abbreviated format is known in the art as a macros. This can be useful for common sequences of computer interaction that normally take a long time to do. For example if the user wants to save an image, copy to a different directory, and switch to a different program, the sequence of mouse and keyboard steps required to do that may be mapped to a single input or (short set of inputs). The user can program the desired macro, or the macro(s) can be pre-programmed or importable.

In some embodiments, the light source emits light having a known (i.e., registered) wavelength and/or emits light at a known (i.e., registered) angle or directionality. The characteristics of the light are known by or registered with the detector. This avoids the false detection of reflected light because the detector is programmed to detect light emitted at a specific wavelength (or range or wavelengths) and/or from a specific angle or directionality. In some embodiments, the light source is an infrared light source. Alternatively, the light source may emit any other suitable wavelength or range of wavelengths along the electromagnetic spectrum.

In some embodiments, the detector and associated processor detect a change in the reflected pattern of light from the interface to perform an input or sequence of inputs to the computer. In some embodiments, the detector and/or processor may be connected to the computer through a USB cable, but may alternatively be connected through any other suitable cable or connection. Alternatively, the detector and/or processor may be coupled to the computer wirelessly such as through a Bluetooth connection or wireless internet connection. In some embodiments, the detector is a camera. The detector may be an infrared camera or any suitable detector to detect light emitted by the light source and reflected by the interface.

In some embodiments, the processor may run a software algorithm. For example, the software may continuously loop a set of image processing code that will translate into a computer input via, for example, standard USB mouse outputs. In some embodiments, the looped code will 1) recognize a pattern detected by the detector when the interface is in view of the detector, 2) recognize the orientation of the interface and potentially derive information out of the interface's rotational orientation, and/or 3) recognize a change in the pattern detected. The first recognized pattern may be as simple as a protruding sphere (same shape from all sides and the most rounded figured). The sphere may be tracked for movement once the cursor tracking is engaged. Based on the size of the sphere, an algorithm can systematically scan around the sphere to map out the location and status the movable member(s) and/or reflective elements. There may be flexibility for interpretation from multiple angles that the interface can tilt. In some embodiments, if the pattern is lost when checked at each iteration, then the mouse cursor tracking maybe disabled until another iteration picks up on a new pattern, signifying the engagement of the interface.

In one embodiment, the processor takes as input a video stream output from the detector, e.g., a camera that is sensitive to a specific wavelength of light, such as IR or near IR, and filters out the rest. In some embodiments, the detector may detect and/or record the video stream continuously. For example, the detector may detect and/or record the video stream at a rate of at least 0.1 Hz, or any suitable rate. When the system is in use, the detector (camera) sees a device with more than one reflectors reflecting light towards the camera. These reflectors may move, be arranged in different patterns, and appear and disappear. There may be several patterns of how the reflectors are arranged and the patterns may change over time. The processor can analyze the video one frame at a time. In each frame, the processor distinguishes the reflectors from the background by taking advantage of the property that the reflectors reflect back light of the wavelength that the camera is sensitive to, thus allowing for a high signal to noise ratio. Once the reflectors are distinguished from the background, the processor then determines the position of the reflectors, which may correspond to the centroid of the reflectors as seen by the camera. The processor also can determine the shape and size of the reflectors. The position of one or more reflectors can be used to determine the position of a cursor being controlled.

Similarly, the difference in position of a reflector/group of reflectors from one frame to another can be used to determine the motion of a cursor being controlled. The shape and size of the reflectors as seen in the video can be used to provide information about which reflector is being seen, the distance between a reflector and the camera, and/or at what angle the reflector is with respect to the camera. Once the processor has the position information for a number of reflectors, it can compute how far reflectors are from each other and how they are positioned relative to each other. The distance that reflectors are from each other can be used for automatic sensitivity changes; i.e., if two reflectors are spaced at a set physical distance from each other, the distance between the two reflectors in the video frame (taking into account the angle at which the reflectors are relative to the camera) will correspond to the distance the reflectors are from the camera. If the reflectors are farther from the camera, a smaller motion of the reflectors in the video can correspond to a larger motion of the cursor, such that the user does not need to exaggerate motions when standing further away. Similarly, if a reflector is of a set physical size, the size of the reflector in the video can be used as an indication of the distance between the camera and the reflector.

Having the positions of each of the reflectors, the processor can determine the relative positions of the reflectors to each other. Using the relative position information, the processor can detect when the reflectors are arranged in a certain pattern. For instance, the reflectors can be arranged in a line. Another pattern may have one of the reflectors displaced from the line. The appearance and disappearance of reflectors can also be used to define different patterns that the computer can recognize. Once these patterns are recognized, the computer can then assign actions to certain patterns. For instance, one pattern may result in a right mouse click. Another pattern results in a left mouse click. Another pattern may not result in any action and be used solely for cursor control. Other patterns may result in changes in sensitivity, changing between different computers, etc.

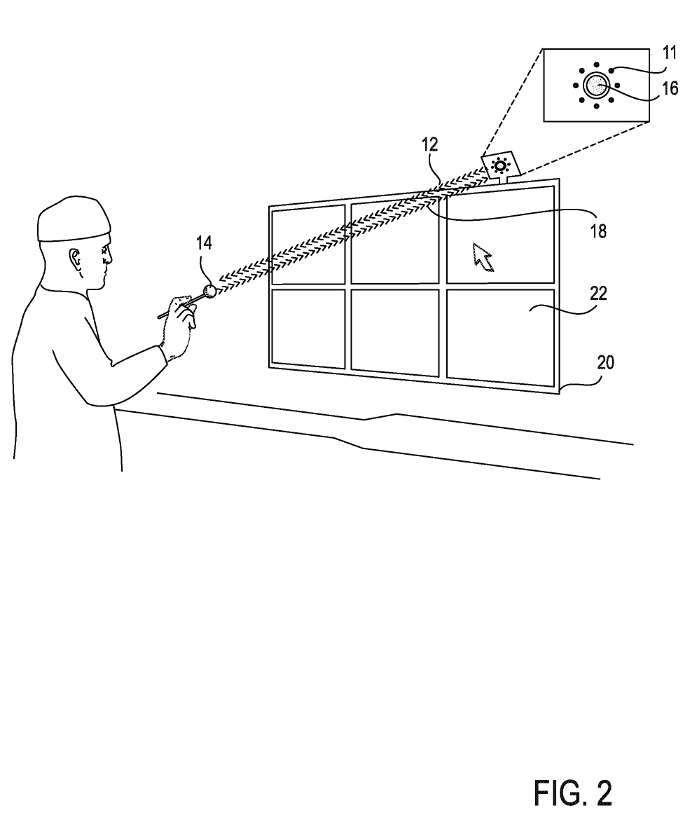

In some embodiments, the light source is positioned close to the detector, while in some embodiments, as shown in FIG. 2, the light source or sources 1I1 surround the detector 16. As shown, light source 11 includes a series of infrared (or other suitable wavelength) light emitting diodes (LEDs) that are positioned around the detector 16. An advantage of positioning the light source close to the detector (or surrounding it) is that the light emitted from the light source can reach the reflective elements of the interface over a wide angle. In FIG. 1, two or more reflective elements (not shown) on the hand-held interface 14 reflect light in at least first and second patterns, and the patterns are changed by moving a movable member (not shown) with respect to the interface body. As shown, the light source and/or detector may be mounted on or near a computer display or screen 20.

As shown in FIG. 1, the computer screen or display 20 may be divided into areas 22 having different functions, and the screen areas may be connected to different computers, as discussed below. Alternatively, screen 20 may be one large screen divided by its operating software into separate sections.

In some embodiments, the interface of the system includes a first and second reflective element that reflect a pattern of light emitted by the registered light source. The interface, as described in further detail below, also includes a body and a movable member coupled to the body that is movable with respect to the body. The movable member moves such that it changes the reflected pattern of light. It is this change that is detected by the detector.

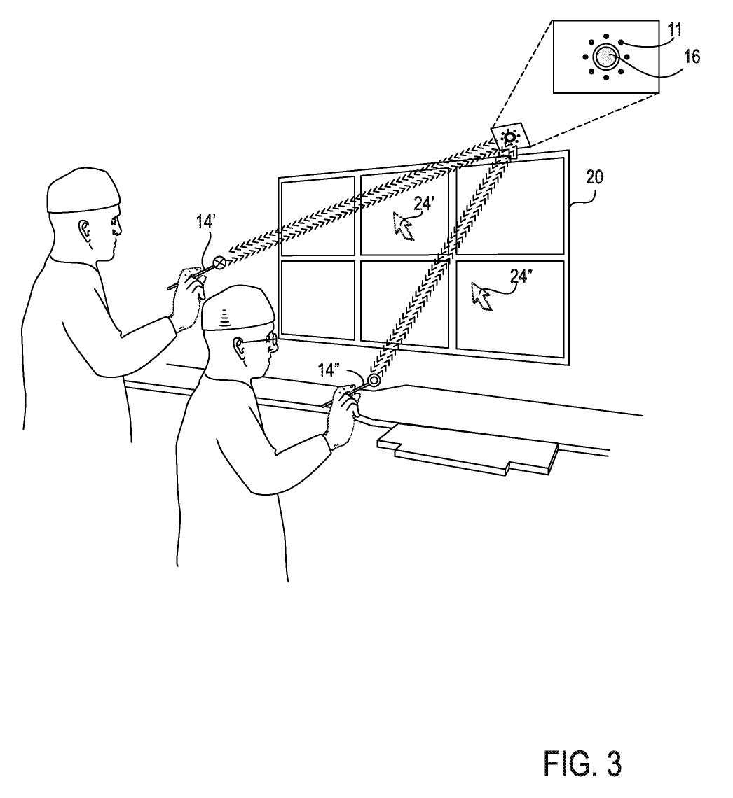

There are scenarios in which the same system will be interacting with more than one user or more than one interface. For instance, two physicians may both want to interact with the same computer within the operating room or one user may use multiple interfaces (for example to interact with different computers/equipment or to use different functions or be logged differently). Thus, as shown in FIG. 3, the system in some embodiments further includes a first interface 14′ and a second interface 14″. As in earlier embodiments, this second interface 14″ may also include at least two reflective elements (not shown) that reflect a pattern of light emitted by the registered light source 11, a body, and a movable member (not shown). In such scenarios it may be desirable to distinguish between the interfaces and perhaps to establish a dominant interface. The two interfaces 14′ and 14″ may each control separate cursors 24′ and 24″, respectively, on the computer screen 20. In some embodiments, a single physical interface may be able to represent more than one interface as recognized by the system (e.g., by switching its pattern of reflected light).

In some embodiments, to distinguish between multiple interfaces, the system recognizes a difference between the interfaces. This difference can take many forms. In some embodiments, the reflective elements of the second interface may reflect patterns of light that are different (i.e., recognizable by the detector) than the patterns of the first interface. For example, one interface can have its reflectors in a row and another can have reflectors in a cross-like configuration. Alternatively, the second interface may reflect the same patterns as the first interface.

In an alternative example, the reflective elements of the first interface may have a first spectral response (e.g., reflect or absorb a specific wavelength, or range of wavelengths) and the second interface may have a second spectral response. The second spectral response may be different from the first spectral response. In some embodiments, the reflective elements of the first interface may reflect a first color of light, and the reflective elements of the second interface may reflect a second color of light.

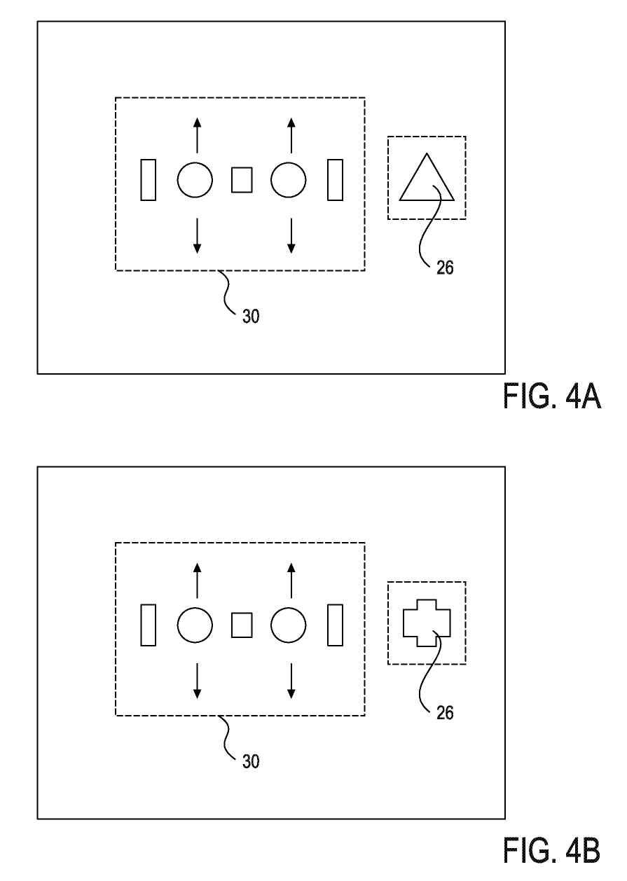

Alternatively, the reflective elements of the first interface may reflect a first shape or shapes of light and the reflective elements of the second interface may reflect a second shape or shapes of light. Shape may be defined as the shape of the individual reflector(s), the pattern of light reflected by each reflector (e.g., checkered or stripped), the size of the individual reflector(s), and/or any combination thereof. For example, as shown in FIG. 4A, one interface may have a triangle reflector 26 to distinguish between the interfaces while another, as shown in FIG. 4B, has a cross shaped reflector 28.

In some embodiments, as shown in FIGS. 4A and 4B, the circular and rectangular reflectors 30 may be constant across the reflectors and may function to perform an alternative function. If the system uses certain patterns of reflectors (for example, circular and rectangular reflectors 30), with specific relative locations, shapes, and/or sizes for other functions (e.g., controlling clicking, sensitivity, input changing, etc.), there can be an alternative region of the interface that is reserved for reflectors that distinguish between interfaces (for example a triangle reflector 26 (FIG. 4A) or a cross shaped reflector 28 (FIG. 4B)). Any combination of the above or other methods can be used to distinguish between interfaces. In the embodiments having reflectors of different sizes, if the reflectors are spaced the same distance apart, for example, the system is able to tell that the reflectors are of different sizes even if the interfaces are held at different distances from the detector.

In some embodiments, at least one of the interfaces may include a light source. The light source may be in addition to or replace the reflective elements. The light source may emit light of the same wavelength as the registered light source (e.g., infrared) or may alternatively emit a different wavelength. In some embodiments, the light source may function to identify between interfaces, while the reflective elements may still function to indicate a computer input such as a mouse click, etc. Alternatively, the system may further include a reflective element or light source coupled directly to the user (e.g., coupled to the surgical cap or gown for example). This additional reflective element or light source may function to identify the different interfaces based on their proximity to the element coupled directly to each user.

Once interfaces or users are distinguished by the system, the system can perform any number of functions or combinations thereof. In some embodiments, the processor is further adapted to recognize the first interface as being dominant over the second interface, or vice versa. For example, when more than one interface/user is interfacing with the same computer/equipment, the interfaces can have equal or different privileges or dominance. If there is equal dominance, both interfaces/users can interface at the same time. The system can alternatively assign different dominance such that the only the interface with the highest dominance interacts with the computer/equipment. Alternatively, the less dominant interface/user can interact after a given period of time (e.g., 0.5 s) after interaction from a more dominant interface/user. For example, dominance between interfaces can be useful when a physician is working with other physicians, nurses, trainees, technicians, etc. The privileges and dominances can be defined in the interface system and/or a preset dominance option may be available. Alternatively the higher dominance may be given to the first interface/user the detector detects. Alternatively, multiple interfaces can be simulated by having control toggle between different interfaces/users.

In some embodiments, the system (e.g., the processor) is further adapted to recognize that the first interface has a first calibration setting and that the second interface has a second calibration setting. In this embodiment, the system may automatically switch the calibration setting (e.g., sensitivity, speed, smoothness, etc.) depending on the interface that is interacting with the system at a given moment. In some embodiments, a single user may switch calibration settings by switching interfaces (which may be useful for different operations) or switching the reflectors or light sources on his/her clothing/headwear.

In some embodiments, the system (e.g., the processor) is further adapted to detect movement of at least one of the reflective elements on the first interface and to translate the movement to movement of a first cursor on a screen. The system may also detect movement of at least one of the reflective elements on the second interface and to translate the movement to movement of a second cursor on a screen. The two cursors may therefore identify between the two interfaces. The cursors may have different, shapes, colors, transparencies, blink rates, etc.

In some embodiments, the system is further adapted to assign the first interface to one or more computers/equipment and the second interface to other computers/equipment. This feature may be desirable to allow different users to interact with different computers/equipment simultaneously or within the same procedure and/or for a single user to switch between different computers/equipment. In some embodiments, the system is further adapted to record the inputs from each interface and record and/or log the inputs specific to each interface.

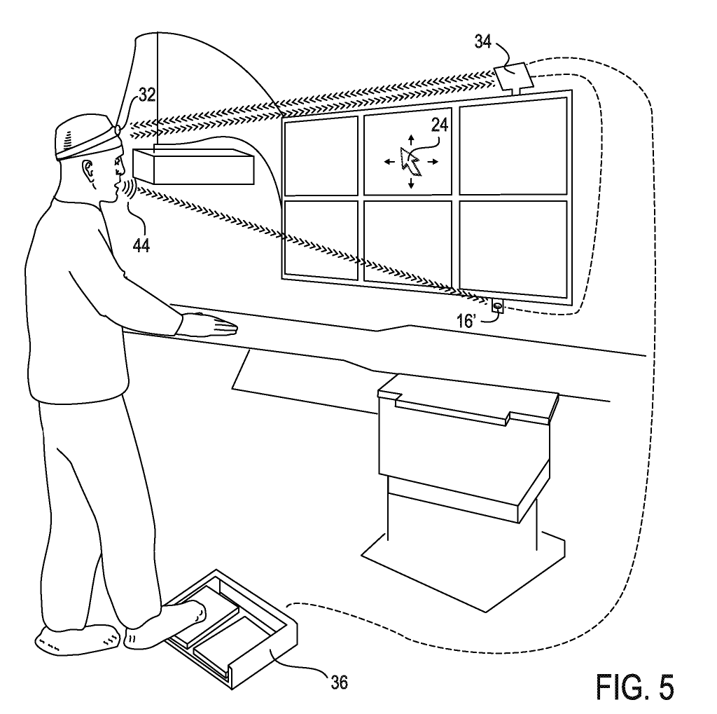

As shown in FIG. 5, in some embodiments, the first reflective element 32 of the interface of the system is coupled to a head of a user. In some embodiments, the processor 34 is further adapted to detect movement of the reflective element on the head of the user and to translate this movement to movement of a cursor on a screen 24. During a procedure, a physician may have both hands occupied with controls and instruments. A reflector on another part of the body, like the head, may be used for additional control. For example, a surgeon may have forceps in one hand and scissors in another, but may still want to control an endoscopic light or camera angle. Head motion may be used to point the endoscopic light or camera. Similarly, head controls may be used to direct an additional articulated joint on an instrument or, for example, control the tip direction of a cauterizing device. This can be done at the sterile field or elsewhere remotely. The detection of the Head-based reflectors by the detector can control a computer or camera, for example, in an intuitive manner. For example, movements of the head reflector may be translated to the computer such that the image on a screen changes. For example, moving up shows the image at a virtual viewing angle further down, moving right shows the image further left, moving forward zooms in, etc. In one embodiment, the image can be the 3D reconstruction of the images taken from laparoscopic cameras.

In some embodiments, as shown in FIG. 5, the system further includes a foot pedal 36. Activating the foot pedal 36 may be used to perform at least one of a computer mouse click, a computer mouse scroll, a keyboard input, and a combination thereof. For example, the reflector 32 on the head of the user may be used to track the movement of the cursor 24, and the user may activate the foot pedal 36 and perform a computer mouse click when the cursor is positioned over an object that the user wishes to select.

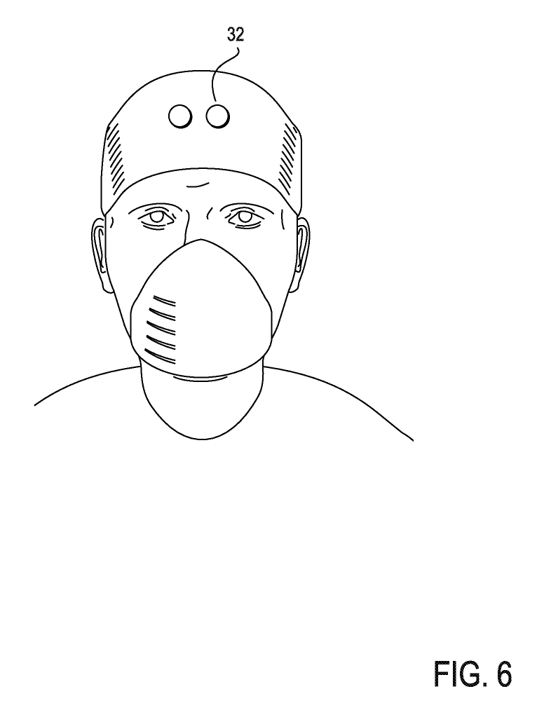

As shown in FIG. 6, in some embodiments, in addition to the first and second reflective elements on the interface the interface of the system further includes a third reflective element 32 coupled to a head of a user. The third reflective element may reflect a third pattern of reflected light emitted by the registered light source that is distinct from the first pattern and the second pattern reflected by the first and second reflective elements on the interface. The detector detecting a change to the third pattern may perform a different computer function or input than a change to the first and/or second patterns.

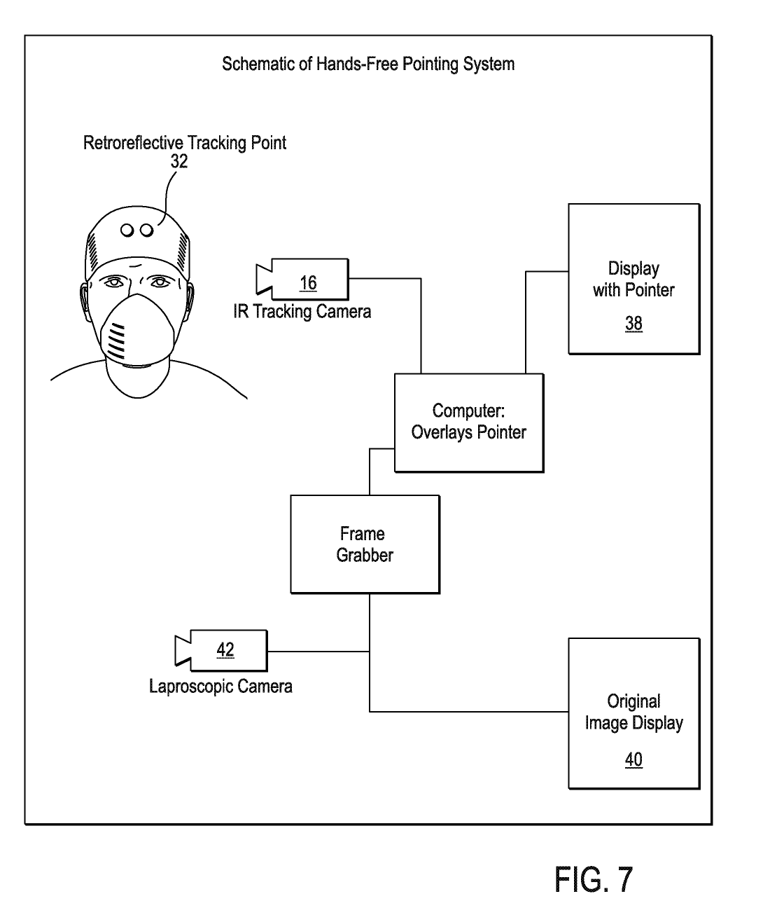

In some embodiments, as shown in FIG. 7, the system having a head reflector 32 may provide inputs to a computer that aid in communication with and direction of trainee surgeons and assistants in a fast, intuitive, and sterile manner. Whereas current practice is limited to mostly verbal communication, surgeons may even stop mid-procedure to physically point out anatomical structures, visual direction during surgery may be desirable. The detector 16 may detect the movement of the head reflector and translate this movement to movement of a cursor on a screen (as shown by box 38). For example, the system may provide the surgeons with control of a pointer overlaid on the laparoscopic image 40 from a laparoscopic camera 42 to facilitate communication.

Also shown in FIG. 5, in some embodiments, the detector 16′ is further configured to detect a voice command 44 and to generate a signal corresponding to the voice command, wherein the processor 34 receiving a voice command signal performs at least one of a computer mouse click, a computer mouse scroll, a keyboard input, and a combination thereof. In some embodiments, the voice command may not literally be a voice of a user, but rather a sound from a user or directly from the interface. For example, the interface may further include a noise-making component. For example the interface may include two ribbed portions that when rubbed upon one another, they may vibrate at a frequency that makes a sound that can be picked up by the detector. In the case where there is more than once interface being used, they may emit different sounds, such as sounds at different frequencies, which can be used to distinguish between the interfaces and/or for which computer they performing an input.

In either case, the system may detect the movement of at least one of the reflective elements of the interface and translate that movement to the movement of a cursor 24 on a screen, as shown in FIG. 5. The foot pedal 36 and or voice command 44 may be activated to perform a mouse click, for example, when the cursor is positioned on the screen in a desired location for a selection or other input. Alternatively, the interface may perform a computer mouse click, for example, and the foot pedal and/or voice command may perform a different function or input, such as a mouse right click for example.

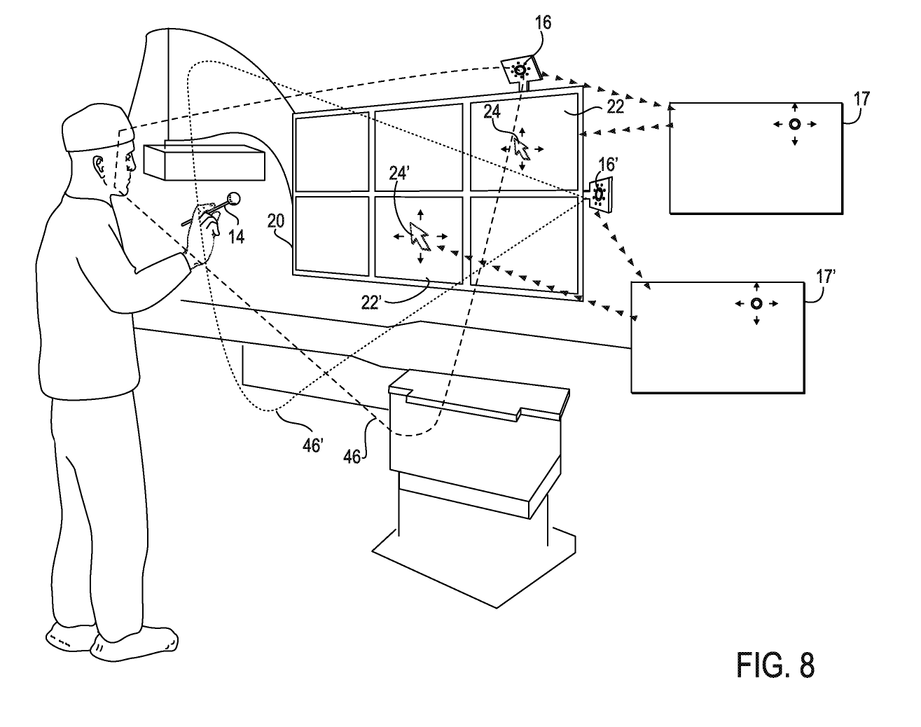

As shown in FIG. 8, in some embodiments, the system further includes a second detector 16′ interacting with the light source, reflective elements (not shown) on or separate from an interface 14, and processor 17′ for detecting a change in position of the reflective elements. As also shown in FIG. 8, the first detector 16 may interact with the light source, reflective elements (not shown) on or separate from the interface 14, and processor 17 for detecting a change in position of the reflective elements. In a first embodiment, the second detector may function to provide a larger detection area. For example, the detectors 16 and 16′ may be cameras having camera angles 46 and 46′, respectively, which may provide a larger detection area than a single camera angle alone. In a second embodiment, the second detector may alternatively function to send an alternative input to the computer. For example, the first detector 16 may detect a change from the first reflected pattern to the second reflected pattern. Processor 17 may identify the change from the first pattern to the second pattern and perform a computer mouse click. The output of processor 17 is in a form recognizable to the computer, and may be displayed by selecting an item with cursor 24 on a first screen area 22, for example. The second detector 16′, for example, when interface 14 is pointed in the direction of detector 16′, may detect the change from the first reflected pattern to the second reflected pattern. Processor 17′ may identify the change from the first pattern to the second pattern and perform a computer switch input, i.e., switch control from a first computer to a second computer. The output of processor 17′ is in a form recognizable to the computer, and may be displayed by switching from cursor 24 on a first screen area 22 to cursor 24′ on a second screen area 22′, for example. For example, the computer may switch from displaying a CT scan (on screen area 22) to displaying a live image from a laparoscope (on screen area 24). Alternatively, the entire screen 20 may show the CT scan, and then the entire screen 20 may be switched to show the live image from a laparoscope.

In a third embodiment, the first and second detectors may allow for the three dimensional (3D) spatial position of the reflective elements to be determined. In some embodiments, the 3D spatial information of the reflective elements can be used to control surgical instruments, for example, in 3D. For example, an instrument could me controlled by the system such that is can be moved back and forth (i.e., toward and away from the detector, for example) in addition to up/down/left/right. This may allow for more degrees of control and more flexibility in how instruments can be manipulated. Alternatively, the different dimensions of movement may be tied to separate inputs or actions. For example, movement in the x-axis may perform an input related to the brightness of the lights, movement in the y-axis may perform an input related to the height of the light from the table, and movement in the z-axis may perform an input related to a camera. In some embodiments, the system may further include goggles that allow for the user 3D viewing of the space within which the manipulation of the computer or instrument occurs.

In some embodiments, the change detected by the system from the first pattern to the second pattern of reflected light further performs at least one of changing an image on the viewing screen, selecting an item on the viewing screen, selecting and dragging an item across the viewing screen, changing function of a cursor, initiating drawing on the viewing screen, stopping drawing on the viewing screen, and measuring a distance on the screen. Particularly, the system may provide the user with the ability to draw or make diagrams on the screen. For example, if a surgeon wanted to lay out where to make an incision and/or point out structures to avoid. In a first embodiment, a user may activate a foot pedal to initiate drawing on the screen. For example the movement of at least one of the reflective elements on the interface or coupled to the user (the movement of the body of the interface) is translated to the movement of a cursor on the screen. Upon activation of the foot pedal (or other suitable input) the cursor begins to draw its path along the screen (following the movement of the reflective element) and stops drawing when the surgeon releases the pedal (or other input). The drawn lines disappear when another pedal is pressed of when the first pedal is pressed again, for example. Other suitable inputs may include voice control, or wireless or wired button on a separate controller, etc. Additionally, other actions can allow for changing line color, width, fill, changing the cursor type, etc. For example, the cursor to a scalpel shape may be associated with a thin blue line, whereas a blood vessel cursor may draw a thicker red line. In some embodiments, certain drawn lines may also allow for certain animations. For example, a user may want to define a dissection by specifying the line from which to dissect and the extent of the dissection (extent could be drawn by drawing an outline around the line). The animation could depict tool tips dissection along the line at various points out to the extent of the dissection.

In some embodiments, the drawn objects may remain on the screen indefinitely or until the user specifies the clearing of the drawn objects. In a second embodiment, the objects may disappear after a certain period of time. In a third embodiment, the object may disappear when the system detects that the image on the screen has changed sufficiently such that the objects not longer accurately correspond with the image on the screen. For example, if the laparoscopic camera moves such that the image on the screen moves more than 5 pixels, the objects may be cleared. The number of pixels/amount of movement may vary and may be specified by the user if desired. In a fourth embodiment, the drawn objects may move along with the image on the screen/from the laparoscopic camera, i.e., they may be tied to specific landmarks or object within the image. This can be accomplished by automatically (or even manually) detecting changes in the image/video on the screen. For example, if the image/video is shown to move 10 pixels to the left, then all drawn objects would also move 10 pixels to the left. Similarly, rotation, zooming, and panning can also be detected and the drawn objects can be rotated, zoomed, and otherwise adjusted appropriately to follow along with the video/image. Reference points of the image/video can be used to help detect changes in the image/video. These reference points can be automatically detected by looking for unique and/or high contrast zones amongst other methods. Reference points can also be specified manually. Alternatively, the camera itself can be tracked using one or more of the following: gyroscopes, accelerometers, reflectors, magnetic tracking, etc.

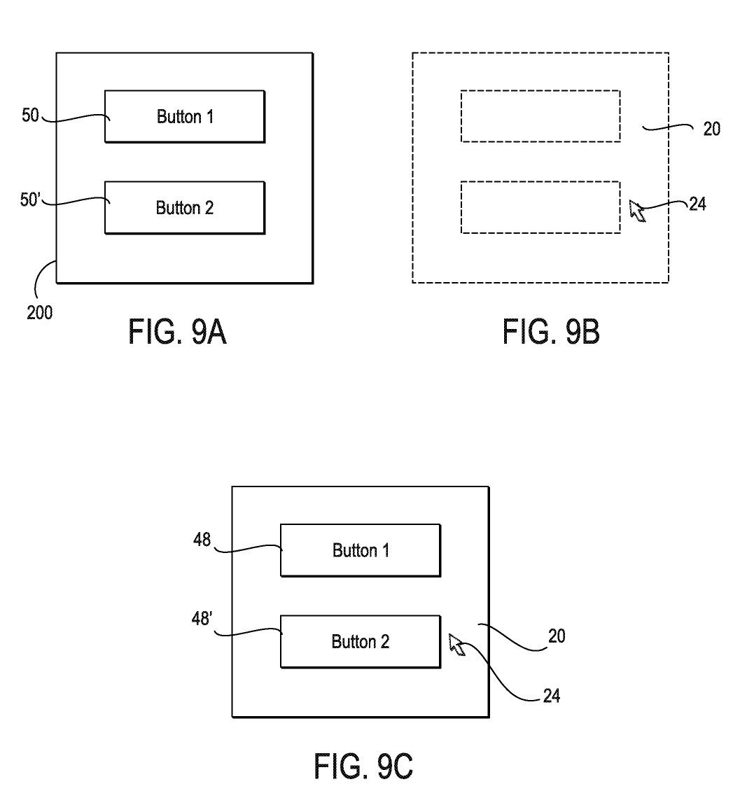

In some embodiments, as shown in FIG. 9C, the screen 20 includes an image of a button 48. An identified change in the reflected pattern from the first pattern to the second pattern may activate the button 48. In some instances, as shown in FIG. 9A, the button is a digital representation of a control mechanism of a physical user interface. For example computers and/or other equipment 200 may include physical user interfaces that require a user to physically manipulate a control mechanism, such as pushing a button 50 or to turning a dial to activate the computer or equipment. The physical interface may not use a mouse/cursor and may not even support use of a mouse or cursor. In some embodiments, the system may be adapted to interact with such computers or equipment. For example, as shown in FIG. 9B, the viewing system (screen 20 that allows for the control of a cursor 24 using an interface as described) may be configured to digitally recreate the layout of the buttons 50 and 50′ on a computer, medical device, or other physical device on screen 20. “Buttons” can refer to physical buttons or clickable objects on a touch-screen. As shown in FIG. 9C, the buttons 50 and 50′ have been digitally recreated as buttons 48 and 48′ and an identified change in the reflected pattern from the first pattern to the second pattern (by the detector/processor) activates the button 48.

For example, a Bovie electrocautery device may only have physical buttons or dials. A screen image that represents the Bovie interface can be output to the screen and the user can interface with the image using the interface. In some variations, the image on the screen may include a simplification with the controls (buttons, dials, etc.), for example, it may only display a subset of the controls. For example, as shown in FIG. 9C, the screen 20 may display an on/off button and a power control dial digitally recreated as buttons 48 and 48′. A user may use an interface (not shown) to move cursor 24 over button 48. The user may then change the reflected pattern from the first pattern to the second pattern. An identified change in the reflected pattern from the first pattern to the second pattern (by the detector/processor) may then activate the button 48. A screen may also include images for multiple computer or equipment controls at once. The interface may also be used to provide inputs to a computer having a touch screen. For example, the interface may be used to perform a mouse click over a digital button on the touch screen and perform the action of that button.

In some embodiments, the system is further adapted to initiate an indication upon the detection of the change from the first pattern to the second pattern. In some embodiments, the indication is a visible indication. In some embodiments, the indication is an audible indication. The signal may function to provide feedback to the user, upon a successful input (e.g., computer mouse click) to the computer for example. In some embodiments, the system may further include a light, such as an LED, coupled to the detector to provide a visible signal or feedback. For example, a green LED could signify cursor tracking and a red LED would signify an off status but that is on standby from handheld tool input. Alternatively, the LED may change colors upon the detector detecting a change in patterns from the reflectors, i.e., a mouse click for example. In some embodiments, the system may include a speaker coupled to the detector to provide an audible signal. The signals may alternatively be provided by any other suitable device or devices.

In some embodiments, the interface may further function to provide feedback to the user. In some embodiments, the interface may further include pressure sensors that give feedback to the operator when instrument movements meet up with resistance from tissues so that the amount of force exerted on tissues is known and controllable.

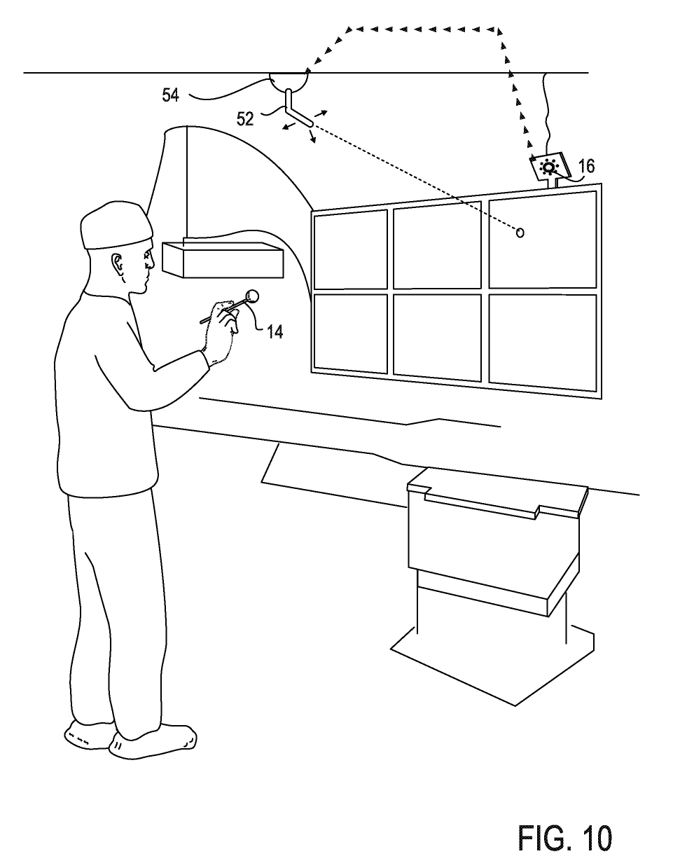

In some embodiments, as shown in FIG. 10, the system further includes a laser pointer 52, and the detector 16 is further adapted to detect the movement of at least one of the reflective elements (not shown) and translate the movement of the reflective element and/or interface 14 to movement of the laser pointer 52. In some instances, a laser or other light pointer may be used in a procedure to directly point at an object that the user wishes to highlight. For example, within an open chest cavity, a surgeon may want to point out a segment of vessel. For example, the detector and processor may detect an input action from the interface and turn the laser pointer on or off. As shown in FIG. 10, a laser pointer may be positioned on a motorized swivel 54 that can be electrically controlled and that controls where the laser pointer 52 points. The movement of the interface 14 may be translated by the detector and processor to the movement of the laser pointer 52 and/or swivel 54.

### Providing Input to a Computer

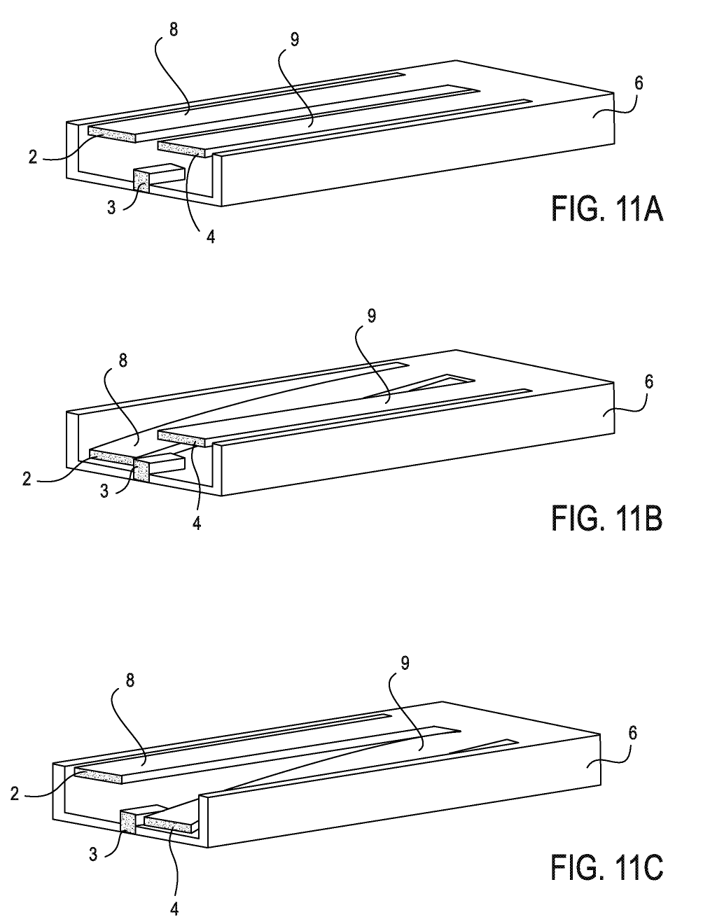

FIGS. 11A-11C show one embodiment of a computer input device or interface of this invention. As shown in FIGS. 11A-11C, a device for providing input to a computer includes body 6, first and second reflective elements 2 and 4 that have at least a first configuration or pattern (as shown in FIG. 11A) and a second configuration or pattern (as shown in FIG. 11B), and a movable member 8 coupled to the body 6. The movable member 8 may be configured to move from a first position (as shown in FIG. 11A) to a second position under an applied load (as shown in FIG. 11B) and then return to the first position (as shown in FIG. 11A and 11C). When the movable member moves, the configuration or pattern of the reflective elements changes from the first pattern to the second pattern.

In some embodiments, as shown in FIGS. 11A-11C, the movable member 8 is a cantilever beam that is configured to bend from a first position to a second position under an applied load and return to the first position upon release of the applied load. The device having a cantilever beam may be one of several variations. In a first variation, as shown in FIGS. 11A-11C, the device includes body 6 and cantilever beams 8 and 9. Reflective elements 2 and 4 are coupled to cantilever beams 8 and 9, respectively. The device also includes reflective element 3 coupled to the body, which remains stationary with respect to the body, such that elements 2 and 4 move with respect to each other and with respect to element 3. As shown in FIGS. 11A-C, the three reflective elements have a plurality of configurations. For example, as shown in FIG. 11A, the neutral position of the cantilever beams may put the reflective elements in a first configuration. As shown in FIG. 11B, cantilever beam 8 may be bent, moving reflective element 2 down with respect to element 3 for a second configuration. As shown in FIG. 11C, cantilever beam 9 may be bent, moving reflective element 4 down with respect to element 3 for a third configuration. The detector and processor (not shown) may detect the change from the first configuration to the second configuration to perform a first input, such as a computer left mouse click, and may detect the change from the first configuration to the third configuration to perform a second input, such as a computer right mouse click. In some embodiments, the cantilever beam is resilient and is configured to bend from a first position to a second position under an applied load (as shown with beam 8 in FIG. 11B) and return to the first position upon release of the applied load (as shown with beam 8 in FIG. 11C). For example, this spring-like recoil or resilience of each beam will return the beam and the corresponding reflective element to the original position in absence of thumb/finger pressing. In other embodiments, the movable member may be lifted against gravity to change the reflective elements from the first pattern to the second pattern, and then released to allow gravity to return the movable member to its original position to change the reflective elements from the second pattern to the first pattern.

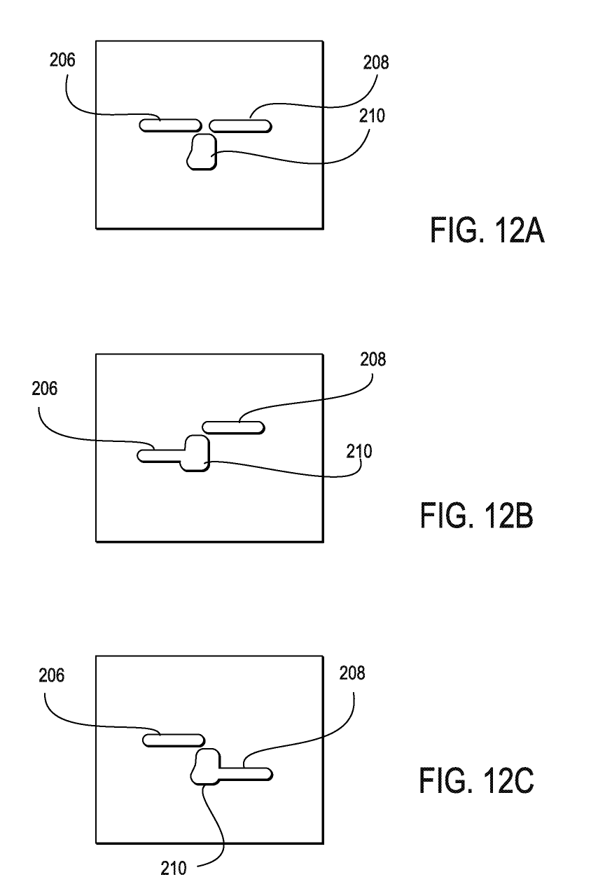

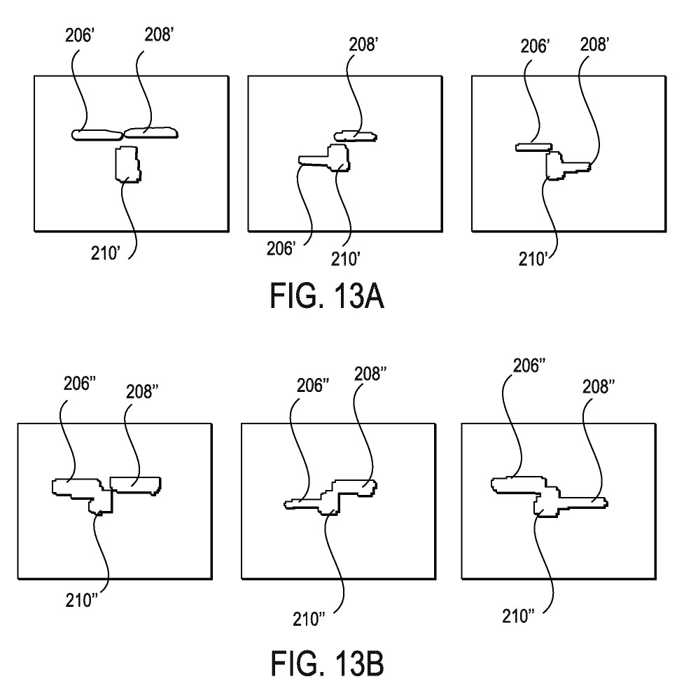

In some embodiments, when the device is used in the system as described, the reflective elements reflect light from the registered light source, and that reflected light is detected by the detector. When the reflective elements are in the first configuration (the neutral position of the cantilever beams, as shown in FIG. 11A), the detector will detect a first pattern of reflected light, as shown in FIG. 12A, wherein the portion 206 of the reflected pattern corresponds to reflective element 2, portion 208 corresponds to reflective element 4, and portion 210 corresponds to reflective element 3. When the reflective elements are in the second configuration (cantilever beam 8 is bent, moving reflective element 2 down with respect to element 3, as shown in FIG. 11B), the detector will detect a second pattern of reflected light, as shown in FIG. 12B, wherein the portion 206 of the reflected pattern corresponds to reflective element 2, portion 208 corresponds to reflective element 4, and portion 210 corresponds to reflective element 3. When the reflective elements are in a third configuration, as shown in FIG. 11C, wherein the cantilever beam 9 is bent, moving reflective element 4 down with respect to element 3 for a third configuration; the detector will detect a third pattern of reflected light, as shown in FIG. 12C, wherein the portion 206 of the reflected pattern corresponds to reflective element 2, portion 208 corresponds to reflective element 4, and portion 210 corresponds to reflective element 3. The detector detects the three reflectors as signal in a spatially relative, two dimensional pattern when the device is within view of the detector. In operation, the device may be angled away from the detector. If, for example, the body was turned in a 45 degree angle to the left, the detector may detect the first, second, and third patterns of reflective light as shown by FIG. 13A. As shown in FIG. 13A, portions of the reflected pattern in a 45 degree angle to the left correspond to reflective elements of the device as shown in FIGS. 11A-11C. The portion 206′ of the reflected pattern in a 45 degree angle to the left corresponds to reflective element 2, portion 208′ corresponds to reflective element 4, and portion 210′ corresponds to reflective element 3. If, for example, the body was turned in a 45 degree angle upwards, the detector may detect the first, second, and third patterns of reflective light as shown by FIG. 13B. As shown in FIG. 13B, portions of the reflected pattern in a 45 degree angle upwards also correspond to reflective elements of the device as shown in FIGS. 11A-11C. The portion 206″ of the reflected pattern in a 45 degree angle upwards corresponds to reflective element 2, portion 208″ corresponds to reflective element 4, and portion 210″ corresponds to reflective element 3. As shown, the reflected patterns differ at the different angles a substantially negligible amount. The detector and or processing unit may be programmed to accept all versions of each of the patterns. Alternatively, the device may further include a shield to prevent detection of the reflective elements at too extreme of an angle to allow for accurate detection. The shield may function to block the reflectors from the detector beyond a maximum angle. In one example, the maximal angle that the reflective elements can be detected by the detector may be 45 degrees.

In some embodiments, a portion of the reflectors may perform a first input and a second portion of the reflectors may perform a second input. For example, as shown in FIG. 11A, the system may detect the movement of reflective element 3 (i.e., the movement of the body 6) and translate that movement to movement of a cursor on a screen. Alternatively, the system may detect the movement of reflectors 2 and 4 for computer mouse inputs. For example, the system may detect the change from the first pattern (neutral configuration) to the second pattern as shown in FIG. 11B as a computer left mouse click and the change from the first pattern (neutral configuration) to the third pattern as shown in FIG. 11C as a computer right mouse click.

The embodiment of the invention shown in FIGS. 11A-11C represents a simple and robust implementation of the system and methods of this invention. In some embodiments, the device may be adapted to be used in a medical and/or sterile environment. All components of the interface may be formed from inexpensive sterilizable materials so that the device can be disposed of or sterilized and reused. The body and movable members may be made, e.g., from lightweight disposable materials such as plastic, but may alternatively be made of any suitable material. The use of a simple design providing a complex combination of reflection patterns provides advantages over prior art computer input devices.

The body may be sized and configured in one of several variations. For example, the body may be sized and configured to be a handheld device and may, for example, resemble a pen, a scalpel, a forceps, a tweezers, a Bovie electrosurgical knife, a drill, a mouse, or any other suitable device or combination thereof. In some embodiments, the body may be sized small enough such that a user can “palm it” (i.e., hold it with the palm of the hand) while holding other tools or objects with the same hand's fingers.

An advantage to having at least two reflective elements includes that there will be less false positives detected by the detector. For example, the detector may have a higher threshold for recognizing an interface device by looking, for example, for three reflective elements (as shown by reflective elements 2, 3, and 4 in FIG. 11A) that are in a predetermined geometric configuration such that they reflect a predetermined pattern. This may help the detector distinguish between an interface device and an unrelated retroreflector, such as a retroreflector on a runner jacket.

In some embodiments, the first reflective element and the second reflective element are infrared (IR) reflective material (including paint), they may alternatively be any suitable material that reflects any suitable wavelength or range of wavelengths. In some embodiments, the reflectors reflecting IR light from the light source to the detector may enhance signal to noise ratios, which may make the processing of the data detected by the detector straight-forward, less computationally intensive, less error prone, less time delayed, and more precise (the reflective elements can be small and there can be multiple independent small reflective elements). Without reflective material, such as IR reflective material, baseline materials such as skin or gloves materials may still reflect IR light from the registered light source, but it may be more difficult to discern the object being tracked from other objects in the sensor's field of view. The reflective elements (made from IR reflective material or other suitable material) allow the device (and system) to be more robust against false positives in the background (e.g., other fingers when a pointer finger is extended out) and can work at a greater range of distances from the emitter and sensor.

The first and second reflective elements have a first configuration and a second configuration (to create first and second reflection patterns) that may be one or any combination of several variations. In some variations, the first reflective element is a material that has a first spectral response and the second reflective element is a material has a second spectral response that is different from the first spectral response. For example, the different reflectors may absorb or reflect different wavelengths of light. The reflectors may reflect different colors of light.

Alternatively, in some variations, the first reflective element is a first shape and the second reflective element is a second shape that is different from the second shape. Shape may be defined as the shape of the individual reflector(s), the pattern of light reflected by each reflector (e.g., checkered or stripped), the size of the individual reflector(s), and/or any combination thereof.

In some variations, the combination of the first, second, and/or additional reflective elements may create the various configurations and reflection patterns. For example, the elements may move with respect to one another, or one or more of the reflective elements may be blocked and/or exposed. One can cover up reflective element partially or fully by putting an object (such as the movable member or a portion of the body) in the line of sight of the detector. One can also unsheathe a reflective element. One can rotate a reflective element, translate a reflective element, enlarge/shrink a reflective element, or change the angle of sight onto the reflective element. In some embodiments, the patterns and/or configurations of the reflective elements must be mutually exclusive at all angles or from a range of angles.

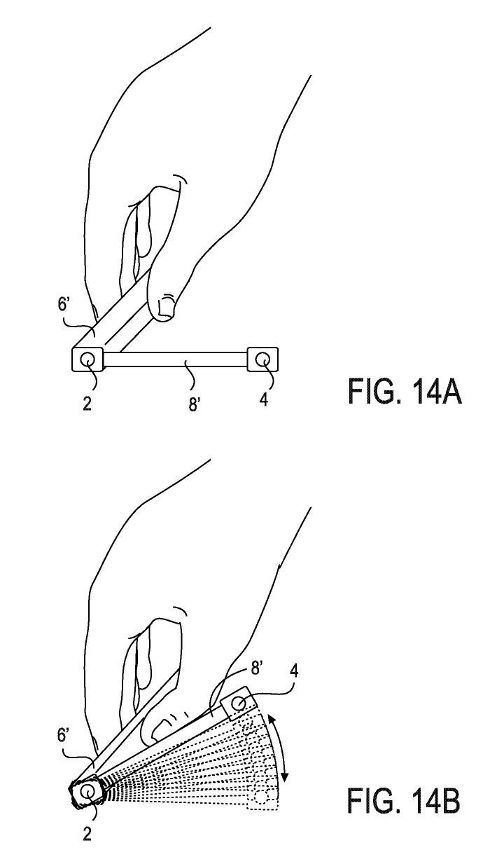

In some embodiments, at least one of the reflective elements is coupled to the movable member. In these embodiments, the movable member moves the reflective element and changes from the reflective elements in the first configuration to the reflective elements in a second configuration. For example, as shown in FIGS. 14A and 14B, the first reflective element 2 is coupled to the body 6′, and the second reflective element 4 is coupled to the movable member 8′. In this example, the detector and/or processor of the system may translate the movement of element 2 to the movement of a cursor on a screen, while the movement of the movable member 8′ and the reflective element 4, and the detection thereof by the detector, may perform an input such as a computer left/right mouse click, scrolling, mouse movement speed/precision, or other computer inputs. The movable member moves such that it rotates reflective element 4 about the longitudinal axis of the body and/or about the reflective element 2. The reflective element 2 may be the pivot point and may also therefore be rotated; however reflective element 4 may be rotated over a greater degree of rotation.

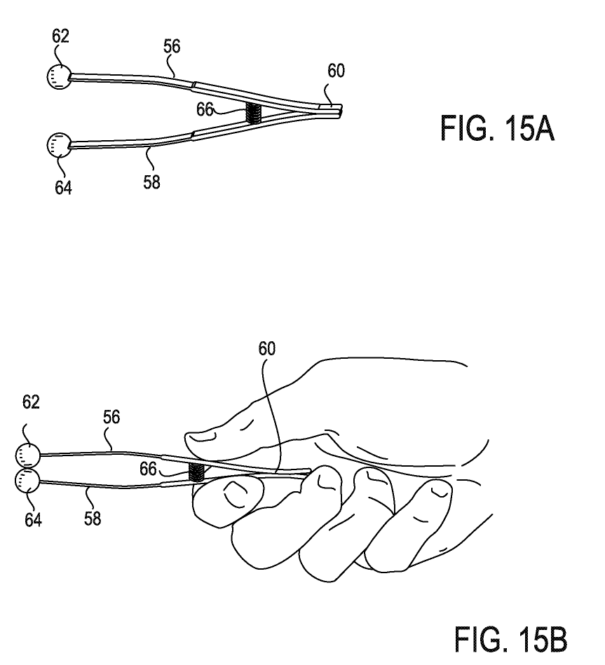

In another embodiment of the computer interface device, as shown in FIG. 15A, the device has two movable arms 56 and 58 connected to each other such that the fulcrum or connection point forms the interface body 60. A reflective element 62 and 64 may be coupled to the each of the arms 56 and 58, respectively. In this embodiment, the arms 56 and 58 move toward each other, as shown in FIG. 15B, under a force exerted against the action of a spring 66, which provides a return force when the applied load is released. Alternatively, the device may not include spring 66, and the arms 56 and 58 may function as cantilever beams that bend with respect to the interface body 60. This device may move and be held similarly to a forceps-like instrument. Alternatively, in some embodiments, the body of the device may be a surgical instrument, such as a forceps having a first movable member and a second movable member. The reflective elements may be coupled to the movable members of the surgical instrument.

In this variation, by gripping and/or pinching the arms and moving them closer together, the reflective elements may change from a first configuration (as shown in FIG. 15A) to a second configuration (as shown in FIG. 15B). The reflective elements may both be moved towards one another, or alternatively, reflective element 62 may be moved toward element 64, which remains substantially stationary with respect to the device as a whole, or vice versa.

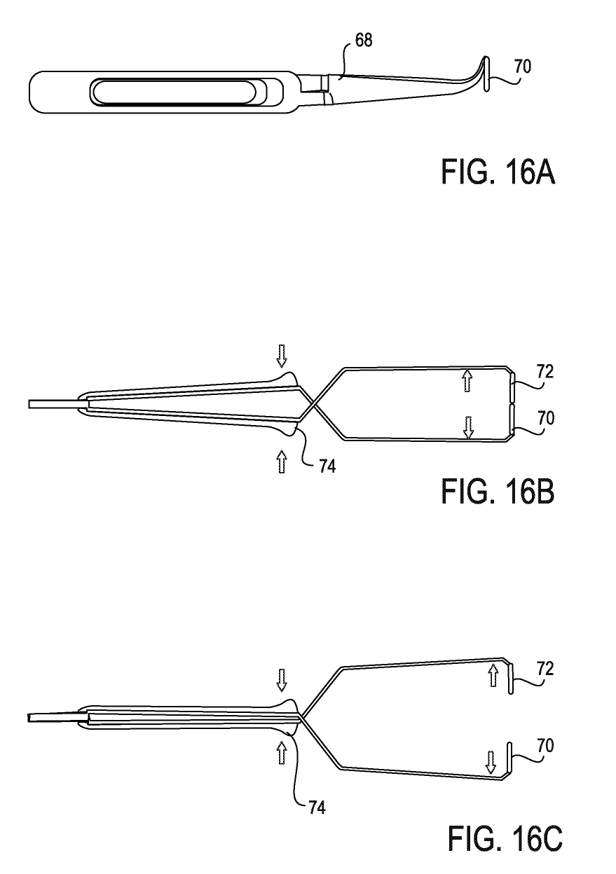

Alternatively, as shown in FIGS. 16A-16C, instead of moving two reflective elements closer with respect to one other, one can use a reverse action tweezers 68, for example. In this example, the reflective elements 70 and 72 start adjacent to one another, as shown in FIG. 16C, and then separate when a user pinches the handle 74, as shown in FIG. 16C.

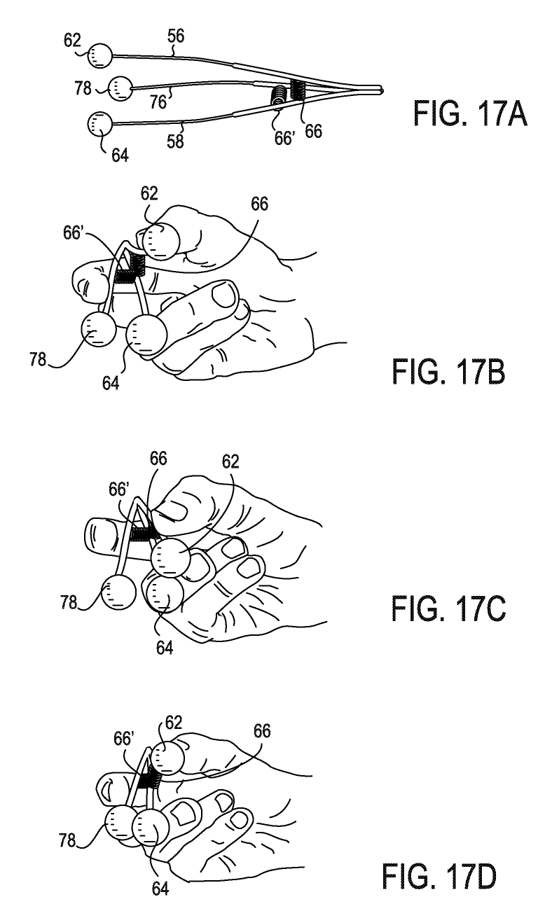

In some embodiments, as shown in FIG. 17A, the interface device may include a third movable member, shown in this example as a third arm 76. A reflector element 78, as shown, is coupled to arm 76. These three reflective elements may have several configurations. For example, as shown in FIG. 17B, the neutral position of the arms may put the reflective elements in a first configuration. As shown in FIG. 17C, a first arm 56 may be bent (and/or pushed against spring 66), moving reflective element 62 down with respect to element 64 and closer to element 64 for a second configuration. As shown in FIG. 17D, a second arm 76 may be bent (and/or pushed against spring 66′), moving reflective element 78 to the right with respect to element 64 and closer to element 64 for a third configuration. The system may detect the change from the first configuration to the second configuration to perform a first input, such as a computer left mouse click, and may detect the change from the first configuration to the third configuration to perform a second input, such as a computer right mouse click. As with the embodiment of FIGS. 15, springs 66 and/or 66′ may be provided to return the arms to their at rest positions after removal of any applied loads.

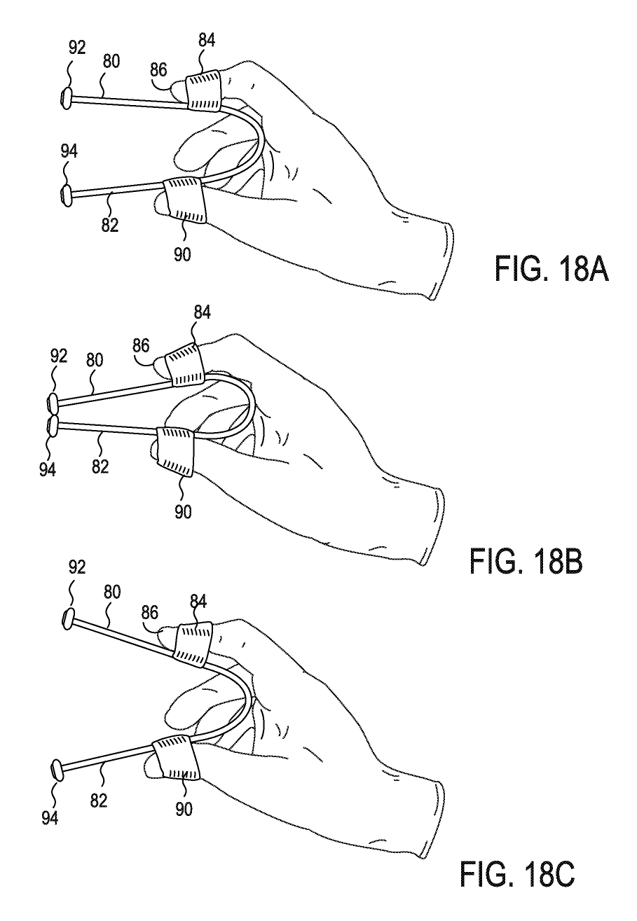

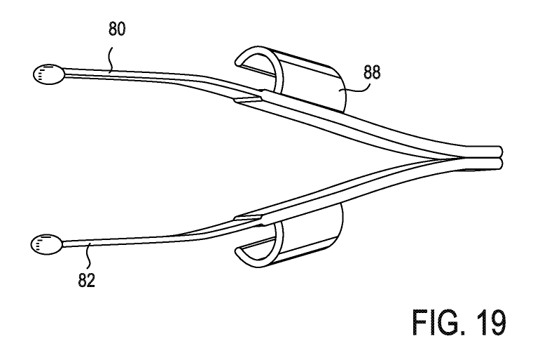

In some embodiments, as shown in FIGS. 18A-18C, the interface device is formed as a leaf spring with arms 80 and 82 which further includes a cage 84 coupled to arm 80 and sized and configured to receive a digit of a user 86. As shown in FIGS. 18A-18C, the cage 84 may be a full cage that fully encircles a digit of a user. Alternatively, as shown in FIG. 19, the cage may be a semi-cage 88, such that it only partially encircles a digit of a user.

As shown in FIG. 18A, the device may further include a second cage 90 coupled to arm 82. Reflective elements 92 and 94 may be coupled to arms 80 and 82 respectively. These two reflective elements may have several configurations. For example, as shown in FIG. 18A, the neutral position of the arms 80 and 82 may put the reflective elements 92 and 94 in a first configuration. As shown in FIG. 18B, movable members 80 and/or 82 may move reflective elements 92 and 94 closer together for a second configuration. As shown in FIG. 18C, arms 80 and/or 82 may be pulled apart (by way of the cage(s) coupled to them) to move reflective elements 92 and 94 further apart for a third configuration. The system may detect the change from the first configuration to the second configuration to perform a first input, such as a computer left mouse click, and may detect the change from the first configuration to the third configuration to perform a second input, such as a computer right mouse click.

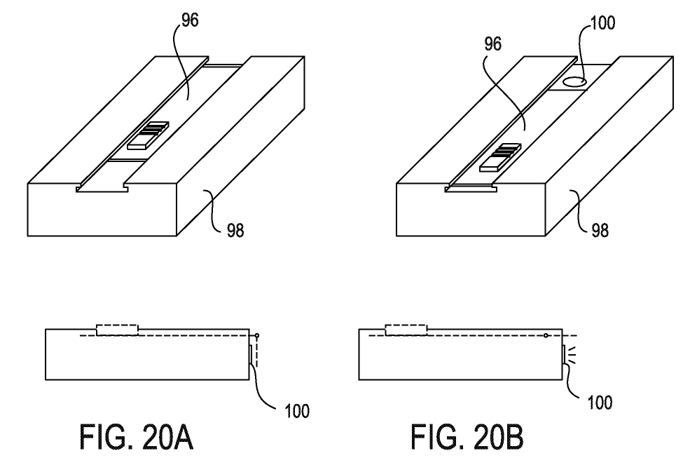

In some embodiments, rather than bending, the movable member may slide with respect to the body from a first position to a second position under an applied load. FIGS. 20A and 20B each show, in both in a perspective view (top) and in a side view (bottom), a device having a movable member 96 that slides with respect to the body 98. As shown, movable member 96 covers the reflective element 100 in the first position (FIG. 20A) and is slid back with respect to the body to expose the reflective element 100 in the second position (FIG. 20B).

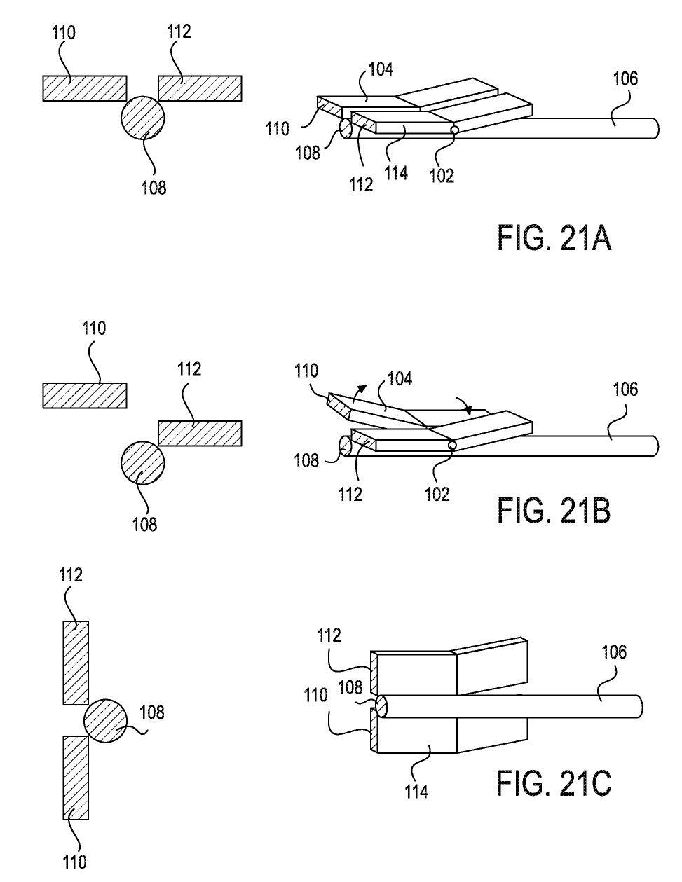

In some embodiments, the device further includes a pivot, and the movable member rotates about the pivot with respect to the body. FIGS. 21A-21C each show, in both in a front view (left) and a perspective view (right), a device having a pivot 102 and the movable member 104 rotates about the pivot 102 with respect to the body 106. As shown in FIG. 21A, the device includes a body 106 having a pivot 102 and a first reflective element 108, a first movable member 104 having a second reflective element 110, and a second movable member 114 having a second reflective element 112. The three reflective elements have a plurality of configurations. For example, as shown in FIG. 2 1A, the neutral position of the movable members may put the reflective elements in a first configuration. As shown in FIG. 21B, movable member 104 may be rotated about pivot 102, moving reflective element 110 up with respect to (and away from) element 108 for a second configuration. As shown in FIG. 21C, the body may be rotated about the longitudinal axis (along the length) of the body such that element 110 and 112 are rotated with respect to element 108. The system may detect the change from the first configuration to the second configuration to perform a first input, such as a computer left mouse click, and may detect the change from the first configuration to the third configuration to perform a second input, such as a computer mouse scroll.

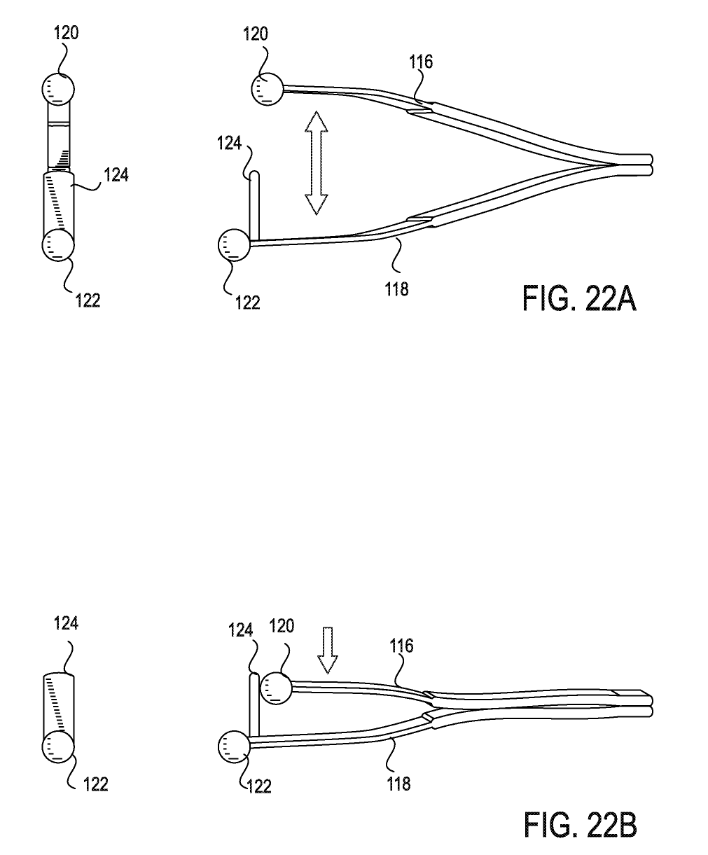

In some embodiments, the movable member moves to change the reflective elements from the first configuration to a second configuration by obstructing and/or exposing at least one of the reflective elements. For example, a reflective element can be engaged (reflecting and detectable) or disengaged (not reflecting and/or not detectable) by the movable member mechanically covering or uncovering the reflective element by blocking the line of sight between the light source and/or the detector and the reflective element. In a first variation, as shown in FIGS. 22A and 22B in both in a front view (left) and a side view (right), the device includes movable member 116 having reflective element 120 and movable member 118 having reflective element 122. As shown, the body of the device and/or movable member 118 includes a screen 124 that functions to block the line of sight between the light source and/or the detector and reflective element 120.

These two reflective elements may have several configurations. For example, as shown in FIG. 22A, the neutral position of the movable members may put the reflective elements in a first configuration where both reflective elements 120 and 122 are exposed (able to reflect and detectable). As shown in FIG. 22B, movable members 116 and/or 118 may move reflective elements 120 and 122 closer together for a second configuration. Movable member 118 may move the screen 124 to obstruct reflective element 120 and/or movable member 116 may move reflective element 120 behind the screen 124 to obstruct reflective element 120. The system may detect the change from the first configuration to the second configuration to perform a first input, such as a computer left mouse click. Alternatively, the system may detect the change from the second configuration to the first configuration (the exposure of reflective element 120) to perform an input.

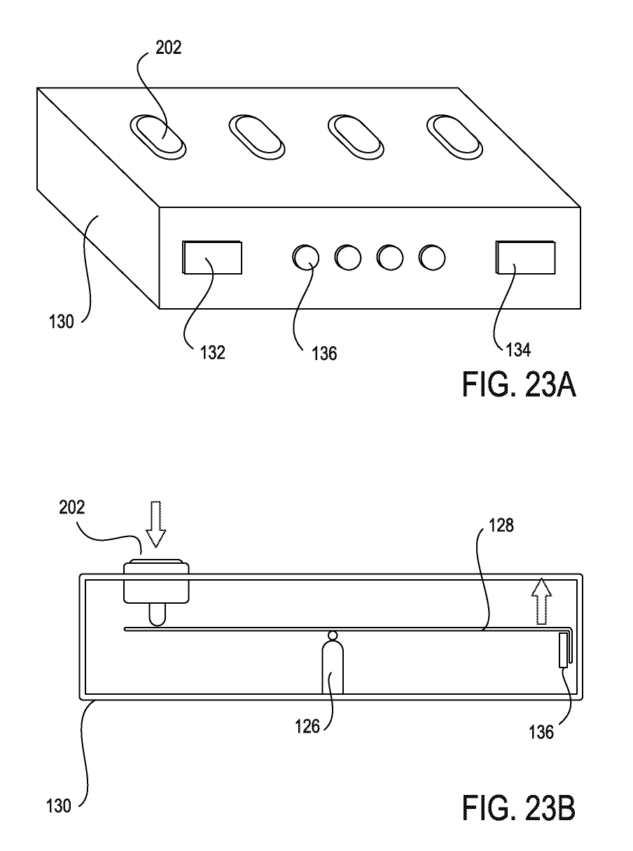

In a second variation, as shown in FIGS. 23A and 23B, the device further includes a pivot 126 and the movable member 128 rotates about the pivot with respect to the body. As shown in FIG. 23B, the device includes a body 130 having a pivot 126, a movable member 128, a button 202 coupled to the movable member, and a reflective element 136. The device, as shown in FIG. 23A, also includes stationary reflective elements 132 and 134 and changing reflective elements 136 (also shown in FIG. 23B), and a button 202 coupled to the first movable member 128. The elements 132 and 134 may provide constant reference points. The movement of these elements (by moving the body) may be translated to the movement of a cursor on a screen. The various reflective elements may have several configurations. The configurations of the elements may be changed by obstructing and revealing the reflective elements in various patterns. In some instances, as shown in FIG. 23B, the user presses button 202 which will rotate the moveable member 128 about the pivot 126 to block or expose the reflective element 136.

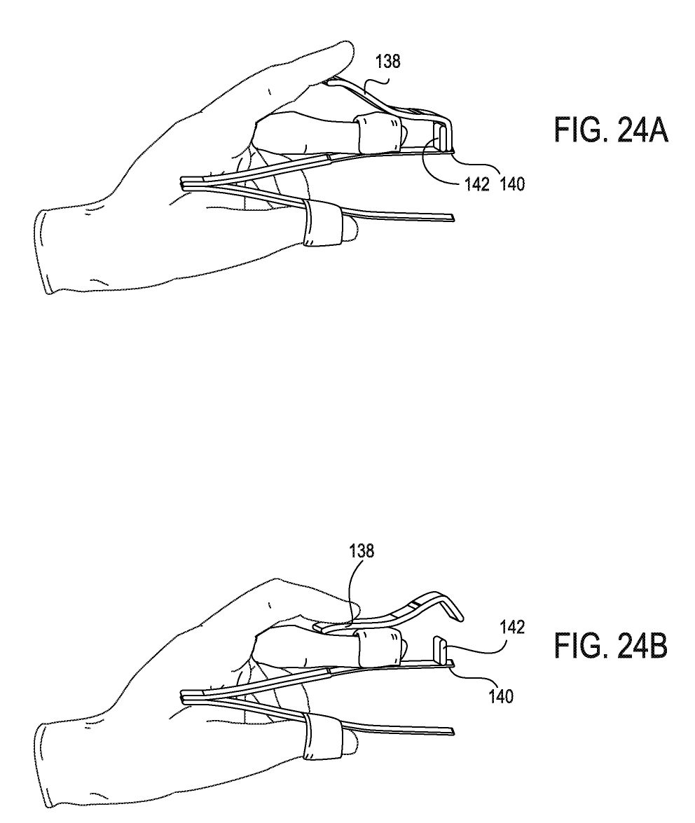

In a third variation, as shown in FIGS. 24A and 24B, the device includes movable member 140 having reflective element 142. As shown, the movable member 140 includes a second movable member 138 that functions as a screen and functions to block the line of sight between the light source and/or the detector and reflective element 142. This reflective element may have several configurations. For example, as shown in FIG. 24A, screen 138 is obstructing reflective element 142 for a first configuration. As shown in FIG. 24B, screen 138 moves such that the reflective element is exposed (able to reflect and detectable) for a second configuration. The system may detect the change from the first configuration to the second configuration to perform a first input, such as a computer left mouse click. Alternatively, the system may detect the change from the second configuration to the first configuration (the obstruction of reflective element 142) to perform an input.

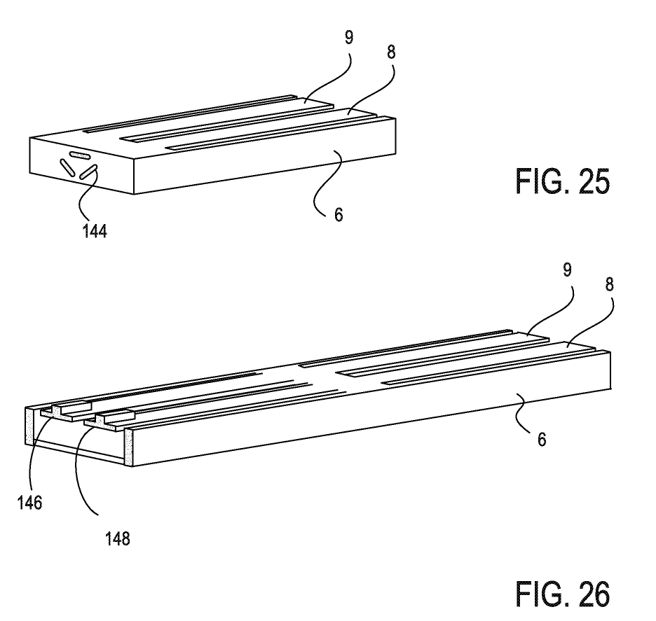

In some embodiments, as shown in FIG. 25, the device further includes a third reflective element 144 having an orientation with respect to the body 6 that is different from the orientation of the first and second reflective elements, coupled to movable members 8 and 9. For example, the third reflective element 144 is positioned substantially opposite from the first and second reflective elements with respect to the body 6. In other words, the first and second reflective elements are on the front end of the device and the third reflective element is on the back end of the device. Alternatively, the body of the device could be L-shaped, such that the first and second reflective elements are on a first end of the device and the third reflective element is on a second end of the device that is substantially 90 degrees from the first end.

In some embodiments, the third reflective element is distinct from at least one of the first reflective element, the second reflective element, and the combination thereof. In some embodiments, the third reflective element may reflect light in a third pattern and the third pattern detected by the detector may perform a different function than the change detected by the detector from the first pattern to the second pattern. For example, the third pattern may perform a computer switching input, i.e., the inputs from the interface will switch from being directed to a first computer to being directed to a second computer.

In some embodiments, as shown in FIG. 26, the device further includes a third and fourth reflective element 146 and 148 having an orientation with respect to the body 6 that is different from the orientation of the first and second reflective elements, coupled to movable members 8 and 9. In some embodiments, as shown in FIG. 26, the fourth reflective element may have the same orientation as the third reflective element such that the third and fourth reflective elements multiple configurations (i.e., at least a third and fourth configuration that are created in a manner similar to those described for the first and second reflective elements). In some embodiments, the third and fourth reflective elements are distinct from the first and second reflective elements. For example, reflective elements 146 and 148 are T-shaped reflective elements, while reflective elements 2 and 4, as shown in FIG. 1 IA, are rectangular shaped reflective element. The elements may alternatively have any suitable shape. In some embodiments, the third and fourth configurations are distinct from the first and second configurations, respectively. In some embodiments, the third and fourth configurations may reflect light in a third and fourth pattern respectively, and the change detected by the detector from the third pattern to the fourth pattern may perform a different function than the change detected by the detector from the first pattern to the second pattern. For example, the change from the third pattern to the fourth pattern may perform a computer switching input, i.e., the inputs from the interface will switch from being directed to a first computer to being directed to a second computer.

In some embodiments, the body sized and configured to be worn by a user. For example, rather than a handheld device, the body may be configured to slide onto a finger or fingers of a user. In this embodiment, the fingers of the user may function as the movable members that move from a first position to a second position such that the configuration of the reflective elements changes from the first configuration to the second configuration. Alternatively, the device may include an adhesive or VELCRO system to couple (in some cases removably) the device to the user.

Alternatively, at least one of the reflective elements may be sized and configured to be worn by a user. For example, the reflective elements may be made of reflective material that may be embedded on the user as part of the sterile and/or biocompatible garments or materials to be worn in various places on a physician's body such as the hand, arm, and neck or as part of the non-sterile regions such as the scrub cap, mask, and goggles. For example, reflective elements may be integrated into a glove, such as a surgical glove. The material may be integrated in one of several variations such as (a) covering a reflective element entirely or partially with a (potentially minimally infrared-absorbing) soft material, such as a surgical glove or gown, (b) painting on reflecting material to a glove or other garment, (c) reflective material in the form of a thread weaved into glove or garment, (d) reflective material in the form of a sticker is placed on the garment, (e) beads or small particles of reflective material may be imbedded in the garment, and/or any other suitable method or combination thereof. The same integration techniques may be used for placement of the reflective materials anywhere on the body or on any object that can be moved by the user. The reflective elements may be positioned in any suitable location such as the palm-side tip of the fingers, such as the pinky finger, the backs of the fingers, the back of the hand, and/or the tips of the fingers. In this embodiment, it may be possible to obstruct a reflective element by bending a finger or placing a hand over the reflective element on the surgical gown or cap.

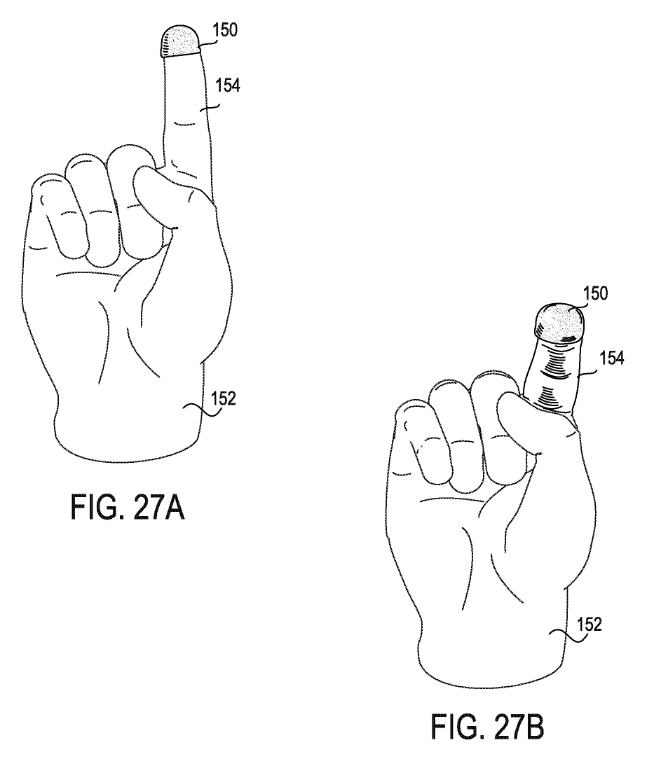

As shown in FIGS. 27A and 27B, reflective element 150 has been integrated into a glove 152. The reflective element has been coupled to the tip of the pointer finger 154 of the glove. In some embodiments, the body of the device is a glove 152 and the movable member is a digit of the glove 154. In this example, the detector and/or processor of the system may translate the movement of element 150 to the movement of a cursor on a screen. For example, as the finger moves down, as shown in FIG. 27B, the detector and/or processor of the system may translate that downward movement to the downward movement of a cursor on a screen. Multiple pointers, which can be made with multiple reflective patches, may be added to add more degrees of control. In addition to the position of each point and the intensity, the number of points and their relative position and movements can constitute gestures that the computer recognizes. If multiple reflective elements are employed, actions such as separating, bringing together, rotation, etc. of the reflecting points on the finger/hand may be used for click/scroll actions. For example, the system detecting two points moving apart can input a zooming command. The system detecting two points rotating in plane can input a rotation command. The system detecting one point moving towards and one moving away, can input a rolling, or rotation perpendicular to the plane of the detector command.

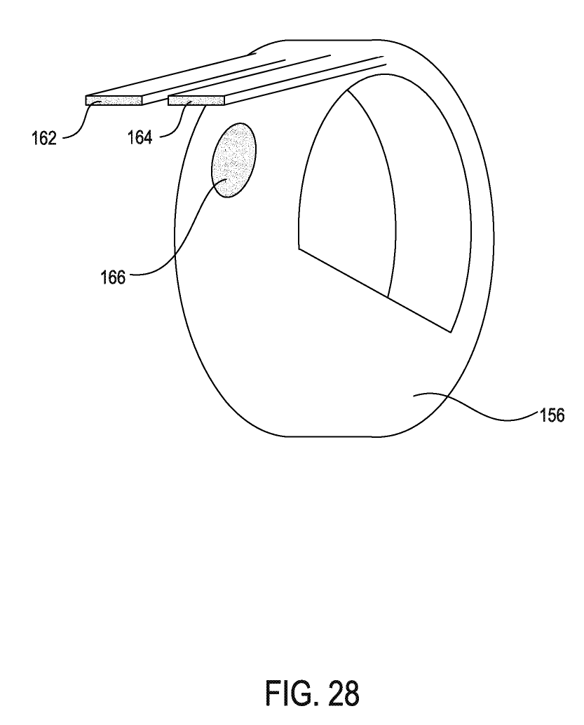

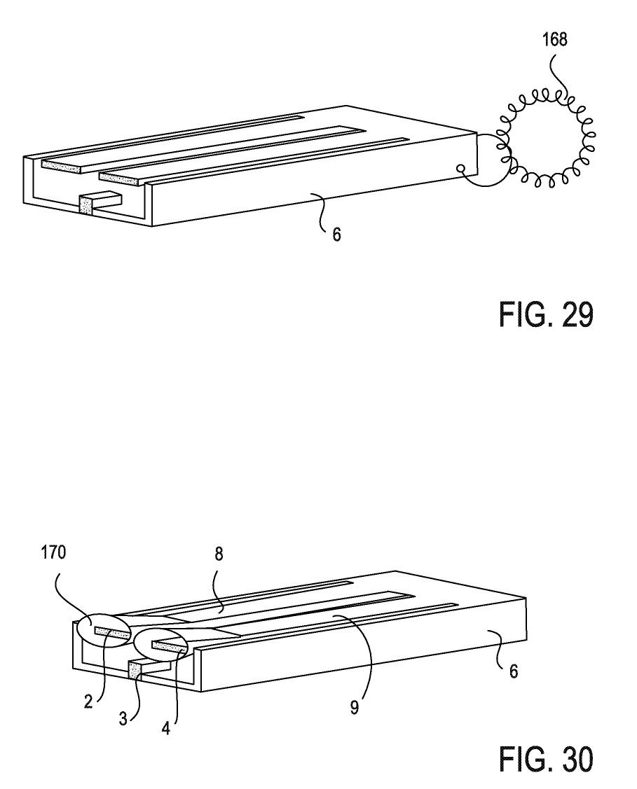

In some embodiments, the body is sized and configured to be worn by a user. For example, rather than a handheld device, the body may be configured to slide onto a wrist or hand of a user, similar to a bracelet, as shown in FIG. 28. As shown, the body 156 of the device is configured to slide onto a wrist or hand of a user. The device includes movable members 158 and 160, reflective element 162, 164, and 166. As shown in FIG. 29, the device may further include a bracelet system 168 coupled to the body 6 of the device such that a user may wear the bracelet system around their wrist or arm.

In some embodiments, as shown in FIG. 30, the device further includes a shield 170 that prevents obstruction of the light reflected from the reflective elements 2 and 4 to the detector (not shown). In use, there may be a propensity for undesirable waste (blood, bodily fluids, etc.) to get onto the reflective element(s), rendering the device ineffective. The shield 170 will prevent this waste from connecting with the reflective elements 2 and 4, and/or it will prevent a user from gripping or touching the reflective elements on the device. The shield may be made of a material and/or positioned on the device such that it does not obstruct the reflective elements from the light source and/or the detector. As described above, the shield may alternatively obstruct the detector from detecting the reflective element an angle that is too wide such that it would affect the accuracy of the detection.

In some embodiments, the method for providing input to a computer includes the steps of emitting light from a registered light source, reflecting a first pattern of reflected light emitted by the registered light source from at least first and second reflective elements, moving a movable member with respect to a body to create a second pattern of reflected light from the at least two reflective elements, and detecting a change from the first pattern to the second pattern to perform at least one of a computer mouse click, a computer mouse scroll, a keyboard input, and a combination thereof.

In some embodiments, as described previously, the emitting step may include emitting light into a sterile field and the reflecting step may include reflecting a first pattern of light from at least first and second reflective elements which are located within the sterile field. In some embodiments, as described previously, the emitting step includes emitting infrared light and the detecting step includes detecting a change from a first pattern of reflected infrared light to the second pattern of reflected infrared light. In some embodiments, the method further includes the step of translating the movement of at least one of the reflective elements to movement of a cursor on a viewing screen. In some embodiments, the method further includes the step of initiating a change from a first visible screen of a viewing system to a second visible screen of a viewing system.

As described throughout, the step of moving the movable member with respect to a body to create a second pattern of reflected light from the at least two reflective elements may be performed in any suitable way. For example, the movable member may move a first reflective element with respect to a second reflective element and/or the movable member may expose or obstruct a reflective element. The pattern of reflected light from the reflective elements may alternatively be change in any other suitable fashion such as by rotating the body about an axis of the body, activating a foot pedal, providing an audible command, or moving a third reflective element coupled to a head of a user with respect to the first or second reflective element.

### Changing a Relationship Between a Reflective Element and a Cursor

In some embodiments, a method for providing input to a computer includes the steps of emitting light from a registered light source, reflecting a first pattern of light emitted by the registered light source with at least two reflective elements, detecting the movement of at least one of the reflective elements, and translating the movement of the at least one reflective element to movement of a cursor on a viewing system such that there is a first relationship between the movement of the at least one reflective element and the movement of the cursor. The method may then also include detecting a change from the first pattern to a second pattern of light with the at least two reflective elements, and changing the relationship between the movement of the reflective element and the movement of the cursor from the first relationship to a second relationship.

In some embodiments, the first relationship and the second relationship are calibration settings. For example, if the detector detects the movement of at least one of the reflective elements it will translate that movement to movement of a cursor on a screen based on the relationship, or calibration setting. The calibration setting may relate to the sensitivity, the speed, the smoothness, or other suitable aspect of the movement of cursor. In some embodiments, the calibration settings can be based on the user's preferences. For instance, the user can change the speed of movement, sensitivity, and smoothness of movement as described by this method by initiating the step of moving the movable member coupled to a body with respect to the body to reflect a second pattern of light with the at least two reflective elements. The system detects this change and changes the relationship (calibration setting) accordingly.

In some embodiments, the relationship is between the distance the reflective element travels and the distance of the cursor travels across the viewing system. In some embodiments, this relationship may be a direct relationship. For example, the distance the interface moves may be a fraction of the distance the cursor moves across the screen or vice versa. In other words, the distance the reflective element travels may be multiplied by a constant (greater than or less than one). Alternatively, the relationship between the movement of the reflective element and the movement of the cursor may be a non-linear relationship such as exponential, logarithmic, or any other suitable function. In some embodiments, there may be a plurality of preset relationships or functions between the reflective element and the cursor and the user may change from one preset function to another. For example, there may be a first relationship suitable for tracking the reflective element to the cursor, a second relationship for “clicking” (in some cases moving one reflective element with respect to another to change the reflected pattern), and a third relationship for measuring a distance on a screen for example.

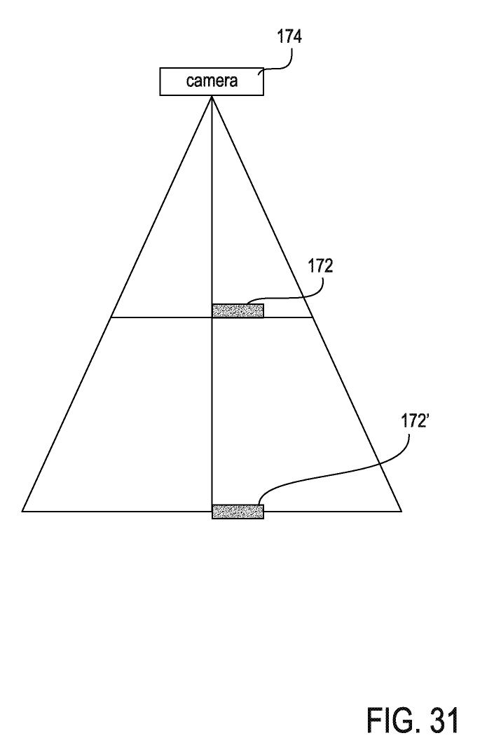

As shown in FIG. 31, in some embodiments, the detecting the movement step further includes detecting the distance of at least two reflective elements from a detector and the function is dependent on the distance of at least one reflective element from the detector. For example, as the distance the reflective element 172 is from the camera 174 increases (moving from 172 to 172′), the perception of movement of the reflective element decreases in an inverse proportion. This can be shown with congruent triangles: Since the lengths of all side of the congruent triangle are the same, change in distance is inversely proportional to the fraction that a length takes up in comparison to the full view. In practice, for different uses, the detector may be placed at different distances from the user holding the retroreflector so there exists a need for the system to adapt to the new distance. In some embodiments, the system can account for the size of the reflective element(s) and be able to estimate the distance the interface is from the detector and scale the movement of the reflective element to the movement of the cursor accordingly. Alternatively the system may scale the cursor movement directly with the size of the retroreflector tool.

In some embodiments, the cursor may need to transverse the computer screen with based on the small or large movements of the interface in some instances, while then needing to be precise enough to make careful measurements in other instances. A user may then wish to change the calibration settings on the fly by initiating an input action (change from first pattern to second pattern) with the interface. In some embodiments, the interface may be shaken by the movements of a user's shaky arm. Also, the act of changing the pattern of reflected light (bending a cantilever beam for example) may also cause a displacement in the cursor location. Therefore, one might need to seamlessly and in real time switch between coarse/fast cursor movement (to move across the screen with small movements) and fine/slower cursor movement where large changes in interface displacement by the user translates to smaller cursor movements and thus is resistant to accidental movements due to arm tremor or displacement via clicking. This switch in calibration setting may again be performed by the user by initiating an input action (change from first pattern to second pattern) with the interface.

In some embodiments, the method may further include the step of moving a movable member, coupled to a body, with respect to the body to reflect a second pattern of light with the at least two reflective elements. As described throughout, the step of moving the movable member with respect to a body to create a second pattern of reflected light from the at least two reflective elements may be performed in any suitable way. For example, the movable member may move a first reflective element with respect to a second reflective element and/or the movable member may expose or obstruct a reflective element. The pattern of reflected light from the reflective elements may alternatively be change in any other suitable fashion such as by rotating the body about an axis of the body, activating a foot pedal, providing an audible command, or moving a third reflective element coupled to a head of a user with respect to the first or second reflective element.

In some embodiments, the moving step may include a rotation of the first reflective element about the second reflective element. The rotation may keep the second reflective element relatively steady such that its movement might be translated to the movement of the cursor (i.e., the cursor would substantially not move as the interface was rotated) while the movement of the first reflective element around the second reflective element may perform a sensitivity or calibration change input. Alternatively, once the interface is rotated to a 90 degree angle, for example, the interface may be used at this angle, as described herein, however the calibration setting for these inputs may be different than the calibration setting for inputs performed while the interface is right-side up (i.e., not rotated 90 degrees). In one example, the 90 degree angle position may be more ideally suited for clicking on small buttons or precisely measuring between two points (e.g., as a digital caliper on a radiographic image).

### Providing Input to a First Computer and a Second Computer

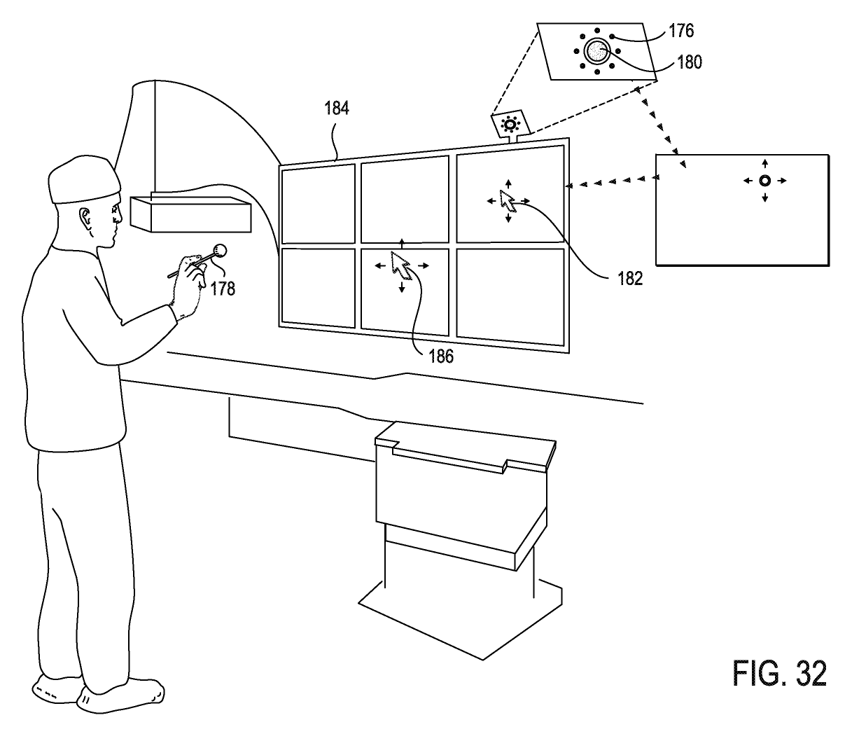

As shown in FIG. 32, a method for providing input to a first computer and a second computer includes the steps of emitting light from a registered light source 176, reflecting light emitted by the registered light source with a reflective element 178, detecting the movement of the reflective element (with detector 180, for example), and translating the movement of the reflective element to movement of a cursor 182 on a viewing system 184 coupled to the first computer. The method further includes the steps of detecting a computer switching input from the reflective element 178, and translating the movement of the reflective element to movement of a cursor 186 on viewing system 184, now coupled to the second computer. In some embodiments, the viewing system includes a first screen coupled to the first computer and a second screen coupled to the second computer. In some embodiments, the viewing system includes a screen that displays a first image coupled to the first computer and a second image coupled to the second computer. In some embodiments, the first computer is coupled to a first viewing system and the second computer is coupled to a second viewing system.

In a first variation, the computer switching input from the reflective element may include changing the configurations of the reflective element(s) and/or the patterns reflected from the reflective element(s). As described throughout, changing from a first pattern or configuration to a second pattern of reflected light or configuration may be performed in any suitable way. For example, the movable member may move a first reflective element with respect to a second reflective element and/or the movable member may expose or obstruct a reflective element. The pattern of reflected light from the reflective elements may alternatively be change in any other suitable fashion such as by rotating the body about an axis of the body, activating a foot pedal, providing an audible command, or moving a third reflective element coupled to a head of a user with respect to the first or second reflective element. Alternatively an additional button or switch on the interface or a unique combination of patterns may engage a computer switching input so that the detector will move the detector output from a first computer to a second computer and thus affecting the cursor engagement of the different screens.

In some embodiments, to initiate a computer switching input, the interface may further include a unique shape (e.g., two stars) at the back of the tool so that the user can simply turn the tool around such that the detector detect the unique shape and engages the screen switch mode. Then the user can move the interface left/right for example, thereby moving the unique shape, to “flip through” the various screens and select the screen. For example, the user may then lower the interface out of the range of the detector or flip the interface back to the front facing the detector and the detector will lock in the newly selected screen.

In a second variation, the computer switching input may include reflecting a third pattern of reflected light emitted by the registered light source from a third reflective element or from a third and fourth reflective elements positioned substantially opposite from the first and second reflective elements with respect to the body. In some embodiments, as described previously and shown in FIG. 25, the device further includes a third reflective element 144 having an orientation with respect to the body 6 that is different from the orientation of the first and second reflective elements, coupled to movable members 8 and 9. For example, the third reflective element 144 is positioned substantially opposite form the first and second reflective elements with respect to the body. In other words, the first and second reflective elements are on the front end of the device and the third reflective element is on the back end of the device. Alternatively, the body of the device could be L-shaped, such that the first and second reflective elements are on a first end of the device and the third reflective element is on a second end of the device that is substantially 90 degrees from the first end.

In some embodiments, the third reflective element is distinct from at least one of the first reflective element, the second reflective element, and the combination thereof. In some embodiments, the third reflective element may reflect light in a third pattern and the third pattern detected by the detector may perform a different function than the change detected by the detector from the first pattern to the second pattern. For example, the third pattern may perform a computer switching input, i.e., the inputs from the interface will switch from being directed to a first computer to being directed to a second computer. In some embodiments, the device further includes a fourth reflective element having an orientation with respect to the body that is different from the orientation of the first and second reflective elements. In some embodiments, the fourth reflective element may have the same orientation as the third reflective element such that the third and fourth reflective elements multiple configurations (i.e., at least a third and fourth configuration that are created in a manner similar to those described for the first and second reflective elements). In some embodiments, the third and fourth reflective elements are distinct from the first and second reflective elements, while in some embodiments, the third and fourth configurations are distinct from the first and second configurations, respectively. In some embodiments, the third and fourth configurations may reflect light in a third and fourth pattern respectively, and the change detected by the detector from the third pattern to the fourth pattern may perform a different function than the change detected by the detector from the first pattern to the second pattern. For example, the change from the third pattern to the fourth pattern may perform a computer switching input, i.e., the inputs from the interface will switch from being directed to a first computer to being directed to a second computer.

In some embodiments, the system includes a second detector such that the detecting the movement of the reflective element step is performed by a first detector and the detecting a computer switching input from a reflective element step is performed by a second detector. In some embodiments, the second detector is positioned at an angle about 90 degrees from the first detector. As previously described and shown in FIG. 8, in some embodiments, the system further includes a second detector 16′ for detecting a change in position of the reflective elements. For example, the first detector 16 may detect a change from the first reflected pattern to the second reflected pattern and perform a computer mouse click. The second detector 16′ may detect the change from the first reflected pattern to the second reflected pattern and perform a computer switch input, i.e., switch control from a first computer to a second computer. For example, the computer may switch from displaying a CT scan to displaying a live image from a laparoscope. Alternatively, the user may want one of these displays to be prominent and larger than the other.

### Defining a Range of Motion of the Reflective Element

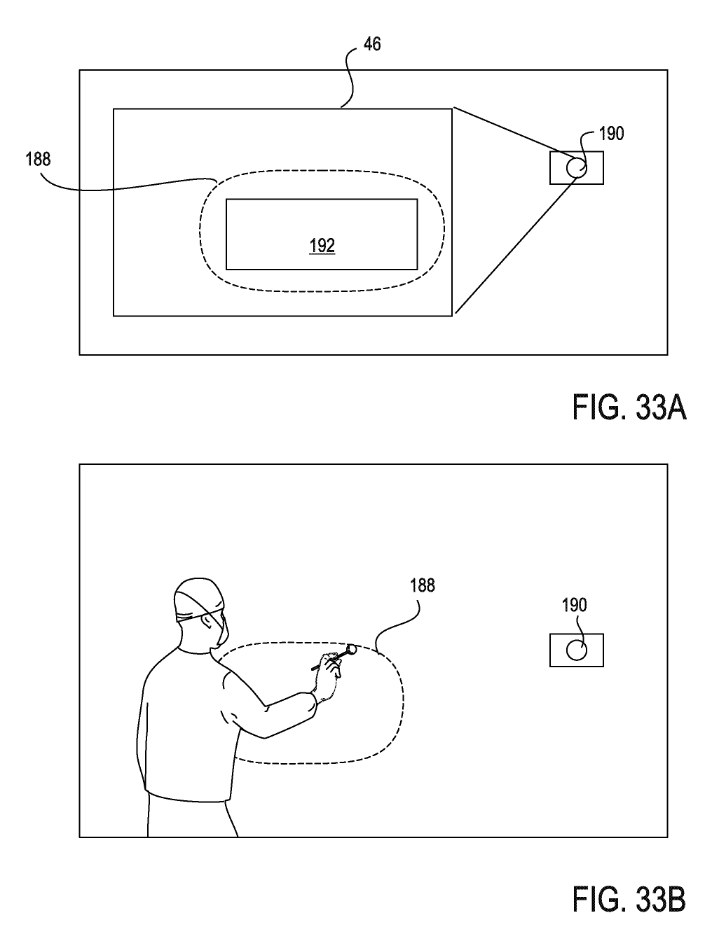

As shown in FIGS. 33A and 33B, a method for providing input to a computer includes the steps of emitting light from a registered light source, reflecting light emitted by the registered light source with a reflective element, defining a range of motion 188 of the reflective element, detecting movement of the reflective element (with detector 190, for example), and translating the movement of the reflective element to a movement of a cursor on a viewing system. The viewing system defines a viewing area 192 and there is a relationship between the range of motion of the reflective element and the viewing area. For example, a user may wish to specify what range of movements they may to make (e.g., the furthest right, left, up, down, forward, and backward) they may wish to move the interface or physically be able to move the interface. Based on this defined range of motion the detector will translate the motion of at least one of the reflective elements to the movement of a cursor accordingly. In some embodiments, the detector has a certain viewing angle 46 and maps the motion of the reflector within that viewing angle to the motion of the cursor on the screen. This may be important both in terms of determining the sensitivity (how much the perceived motion of the reflector gets translated into a certain amount of movement of the cursor) and centering (for example, where within the viewing space of the camera is defined to be a certain space on the screen, ex the center of the screen). The position of the user within the viewing angle of the camera, the distance between the camera and the user, and the range of motion that the user desires may all affect the calibration for the centering and sensitivity when the reflector motion/position is mapped to the cursor motion/position.

The user may calibrate position and sensitivity by letting the system know where they would like to position the working space and by giving an indication of the range of motion (i.e., defining the range of motion). In some embodiments, the range of motion is defined by defining the center of the range of motion and thereby translating the movement of the reflective element to a centered position of the cursor on the viewing area when the reflective element is positioned substantially at the center of the range of motion. In some embodiments, the detecting step further includes detecting the movement of the reflective element outside of the defined range of motion and the translating step further includes translating the movement of the reflective element to a movement of a cursor on the viewing area and the position of the cursor on the viewing area is at an edge of the viewing area.

As shown in FIGS. 33A and 33B, in some embodiments, the range of motion is defined by moving the reflective element around the periphery 188 of the range of motion and detecting the movement of the reflective element. For example, the user may outline their desired working space within the camera angle 46, for example. They can use the reflector to draw out a rectangle (or other suitable shape) in space. This rectangle is detected by the detector and mapped to the computer screen area in such that the cursor moves are fit within that rectangular space.

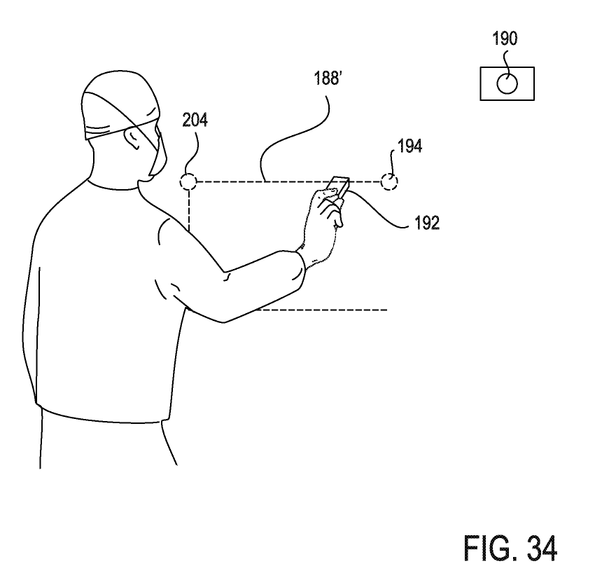

Alternatively, as shown in FIG. 34, in some embodiments, the range of motion is defined by positioning the body 192 at a first location 204 substantially along the periphery 188′ of the range of motion and initiating a “click” (i.e., moving the first reflective element with respect to the body to create a second pattern of reflected light from the at least two reflective elements) and then moving the body 192 to a second location 194 substantially along the periphery 188′ of the range of motion and initiating a second “click”. This may be repeated multiple times to map out the range of motion. For example, the system may ask the user to indicate the 4 corners of a rectangle (for example) that they would prefer to be in their range of motion. Or the system can ask the user to simply draw out the periphery of his/her desired range of motion, as described above, and a rectangle is mapped within that periphery. Although a rectangle is specified above to indicate the mapping to a computer screen, if multiple computer screens are hooked together, or if the screen is a non-rectangular shape, the term rectangle can be expanded to encompass any shape that defines the working space of the computer screen(s) upon which a cursor is moved.

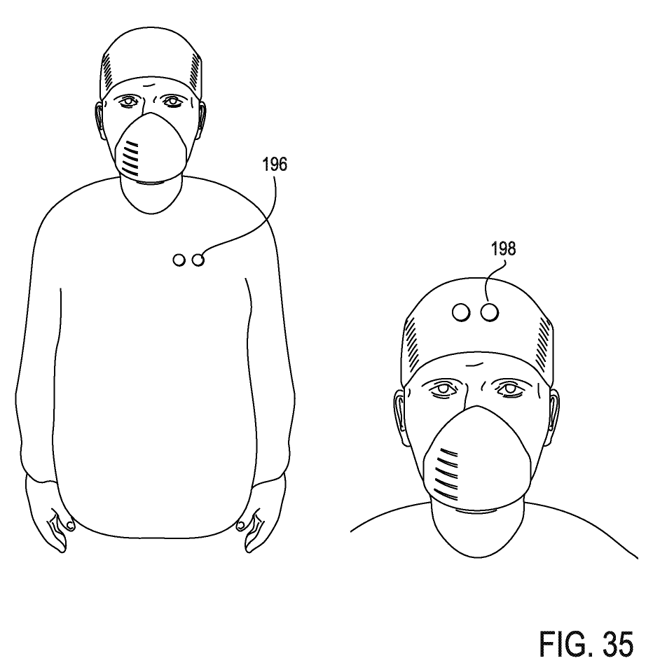

As shown in FIG. 35, in some embodiments, the method further includes the step of reflecting light emitted by the registered light source with a second reflective element 196 that is in a substantially fixed position with respect to the range of motion of the first reflective element, on an interface for example (not shown). For example, the user may have markers on their body 196 that can help to auto-calibrate and/or aid in defining the range of motion. For example, the user may have reflective elements 198 on their cap or reflective elements 196 on their gown. The system may be preset to know where these reference reflective elements are and will automatically determine the approximate range of motion preferred by the user and then map the workspace of the computer screen(s) within that range of motion. This range of motion can be determined to be the average of minimum range of motion expected for users or it can be indicated by the user beforehand. Having more than one reference reflective elements arranged in a certain pattern, or having a known shape of the reflective element(s) can be used to determine how far the user is from the camera, his/her orientation, and to help determine the sensitivity for the calibration (e.g., if the distance between two landmarks on the reflective element(s) is known, a multiple of that distance determines the range of motion).

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A device for providing input to a computer, the device comprising:
a body;
first and second reflective elements that have at least a first configuration and a second configuration; and
a movable member coupled to the body, wherein the movable member is configured to:
move from a first position to a second position under an applied load such that the reflective elements change from the first configuration to the second configuration, and
return to the first position.

2. The device of claim 1, wherein the movable member is configured to return to the first position upon release of the applied load.

3. The device of claim 1, wherein the first and second reflective elements are sterilizable.

4. The device of claim 1, wherein the body is sterilizable.

5. The device of claim 1, wherein the first reflective element and the second reflective element comprise infrared reflective material.

6. The device of claim 1, wherein the first reflective element comprises a material that has a first spectral response and the second reflective element comprises a material has a second spectral response, wherein the first spectral response is different from the second spectral response.

7. The device of claim 1, wherein the first reflective element has a first shape and the second reflective element has a second shape, wherein the first shape is different from the second shape.

8. The device of claim 1, wherein the second reflective element is coupled to the movable member and is movable with respect to the first reflective element.

9. The device of claim 8, wherein the first reflective element is sized and configured to be coupled to the body.

10. The device of claim 9, the interface further comprising:
a second movable member sized and configured to be coupled to the body, and
a third reflective element coupled to the second movable member, wherein the second and third reflective elements are movable with respect to the first reflective element.

11. The device of claim 8, wherein the first reflective element is coupled to a second movable member.

12. The device of claim 11, the interface further comprising a third reflective element, wherein the first and second reflective elements are movable with respect to the third reflective element.

13. The device of claim 8, wherein the second reflective element moves with respect to the first reflective element such that at least one of the reflective elements is obstructed by a portion of the device.

14. The device of claim 8, wherein the second reflective element moves with respect to the first reflective element such that at least one of the reflective elements is exposed by a portion of the device.

15. The device of claim 1, wherein the movable member moves with respect to the body such that at least one of the reflective elements is obstructed by a portion of the movable member.

16. The device of claim 1, wherein the movable member moves with respect to the body such that at least one of the reflective elements is exposed by a portion of the movable member.

17. The device of claim 1, wherein the first and second reflective elements have a first orientation with respect to the body, the device further comprising a third reflective element having a second orientation with respect to the body.

18. The device of claim 17, wherein the third reflective element is positioned substantially opposite from the first and second reflective elements with respect to the body.

19. The device of claim 17, wherein the third reflective element is distinct from at least one of the first reflective element, the second reflective element, and the combination thereof.

20. The device of claim 17, further comprising a fourth reflective element having a second orientation with respect to the body, wherein the third and fourth reflective elements have at least a third configuration and a fourth configuration.

21. The device of claim 20, wherein the third and fourth reflective elements are distinct from the first and second reflective elements.

22. The device of claim 20, wherein the third and fourth configurations are distinct from the first and second configurations, respectively.

23. The device of claim 1, wherein the body is a device sized and configured to be worn by a user.

24. The device of claim 1, wherein the body is a handheld device and the movable member is a cantilever beam coupled to the handheld device.

25. The device of claim 24, wherein the cantilever beam is resilient, wherein the cantilever beam is configured to bend from a first position to a second position under an applied load and return to the first position upon release of the applied load.

26. The device of claim 24, wherein the body is a surgical instrument and the movable member is a movable portion of the surgical instrument.

27. The device of claim 26, wherein the surgical instrument is a forceps having a first movable member and a second movable member, wherein the movable member moves from the first position to the second position by approximating the movable members.

28. The device of claim 24, further comprising a cage, coupled to the movable member, sized and configured to receive a digit of a user.

29. The device of claim 1, the device further comprising a spring, coupled to the movable member, that is sized and configured to allow the movable member to move from a first position to a second position under an applied load and to return the movable member to the first position upon release of the applied load.

30. The device of claim 1, wherein the movable member is coupled to the body so as to be movable in one direction against gravity and movable in an opposite direction with gravity.

31. The device of claim 1, wherein the movable member slides with respect to the body.

32. The device of claim 1, further comprising a pivot, wherein the movable member rotates about the pivot with respect to the body.
